(19) United States
(12) Patent Application Publication
(10) Pub. No.: US 2010/0023452 A1
(43) Pub. Date: Jan. 28, 2010

(54) System and Method for Bill Payment

(76) Inventor: James H. Brown, Philadelphia, PA (US)

Correspondence Address: CONNOLLY BOVE LODGE & HUTZ, LLP, P O BOX 2207, WILMINGTON, DE, 19899, US

(21) Appl. No.: 12/471,961

(22) Filed: May 26, 2009

Related U.S. Application Data
(63) Continuation of application No. 10/417,760, filed on Apr. 17, 2003, now abandoned.

(51) Int. Cl. G06Q 40/00; G06Q 10/00; G06F 17/30

(52) U.S. Cl. 705/40; 707/1; 707/E17.001; 707/104.1

(57) ABSTRACT

The present invention is a system and method for assisting managers in managing invoices received from providers, and in particular for providing assistance to managers in identifying elements of invoices which are likely to be disputed, and assisting managers in disputing elements of invoices which are desired to be disputed by managers. The system may further embody features for assisting managers in managing accounts associated with invoices.

### FIELD OF THE INVENTION

The present invention pertains to systems for facilitating periodic invoice payment, and in particular, to systems for assisting facility or energy managers in managing invoices for a plurality of accounts.

### BACKGROUND OF THE INVENTION

Utility invoices for individual property owners require the individual property owner to review, understand, and analyze the information contained in the invoice in order to determine whether the invoice should be paid in full, or whether the invoice or a portion of the bill should be challenged.

When the utility invoices for a plurality of properties are the responsibility of a multiple property manager or energy manager (hereafter referred to collectively as a “manager” or “managers”), the efficiency with which the managers can review and initiate payment for the invoices becomes a business expense affecting the cost of operation of the underlying business. Although managers so far defined include multiple property managers and energy managers, the term manager refers to any individual or group of individuals who are responsible for managing a plurality of invoices.

The invoices themselves must be analyzed by the manager, such as to determine whether the amount identified as an invoice is reasonable, whether the amount is within budgets, whether the amount indicates a problem with the account, or whether the amount exhibits any potential defects. Thus, a manager will likely desire to compare the invoice to previous invoices for the account, to budgeted amounts for the account, to external factors which may affect the account (such as climatic conditions which affect usage), and to other factors which may indicate a problem with an invoice.

Previous bill payment systems have focused on the invoice from the utility provider's perspective, and largely ignored the perspective of the bill payer. For example, in U.S. Pat. No. 6,035,285, the focus of the system is in obtaining prompt payment of billed amounts from customers. To effect this, the systems provide aggregate amounts owed by the managers in terms of the total amount billed by the utility company. In U.S. Pat. No. 6,052,671 the system includes auditing of the bills, however relies entirely on pre-determined criteria to automate auditing of the bills. Neither system provides the flexibility needed by managers, nor does either system focus its support on the invoice payers. Furthermore, the systems do not provide efficient systems for allowing managers to dispute invoiced amounts.

Errors in the invoiced amounts, such as due to defective meters or improper meter readings, may constitute a significant portion of invoiced amounts. Accordingly, the function of individual managers is to identify invoices that may contain erroneous charges, to contact the provider responsible for the invoice, and to resolve in a rapid fashion any discrepancies on invoices.

The use of automated auditing criteria, such as examination of percentage differences between usage amounts, provides a starting point for identifying problem invoices. For example, if a present month's usage of a service is twice the preceding months usage, automatically identifying the usage amount as potentially defective can provide valuable information to a manager. However, if the property at which the service was being provided was unoccupied the previous month, and occupied in the present month, the doubling of usage could be seen by a manager as entirely within expectations. Accordingly, automatically generating a dispute of the amount would require additional effort on the part of the manager to reverse the dispute status of the amount. Conversely, if the property went from occupied to unoccupied status between months, but the usage amount did not vary sufficiently to cause the amount to be automatically disputed, the manager would be provided with no support for instigating a dispute of the amount.

An additional problem may arise where invoices from different providers are provided in different formats. For example, a usage rate provided by one provider could include taxed amounts within the usage rate, while another provider could itemize the taxed amounts distinctly from the usage rates. A manager would be required to track the significance of each value as provided by each provider, in order to be able to make comparative judgements between providers.

### SUMMARY OF THE INVENTION

The present invention is a system and method for assisting managers in managing invoices received from providers, and in particular for providing assistance to managers in identifying elements of invoices which are likely to be disputed, and assisting managers in disputing elements of invoices which are desired to be disputed by managers. The system may further embody features for assisting managers in managing accounts associated with invoices.

In one form, the present invention may be embodied in an invoice management system for supporting managers in managing invoices. The system may include an invoice management processor. The invoice management processor may be utilized to audit information contained in an invoice to determine if the information is suspect, such that a manager should consider whether the information should be disputed. The invoice management processor may also include software for assisting managers in communicating information associated with a disputed invoice to a provider associated with the disputed invoice. The software may implement generation of e-mail dispute notifications, hard-copy dispute information communications, facsimile transmitted dispute information communications, or any other communication method acceptable to the provider. The invoice management system may also have at least one interface for receiving invoices from provider. The interface may be used to receive information from providers in one or more formats. The interface maintains or converts the information contained on an invoice in an electronic format, such that information contained on the invoice may be analyzed electronically for invoice payment, invoice dispute, and auditing capabilities.

In another form, the present invention may be embodied in a process for assisting managers in managing invoices, comprising the steps of enrolling a customer with an invoice management system, associating at least one account for which invoices are expected with the invoice management system, associating the account with an enrolled customer associated with the account, receiving an invoice associated with the account, auditing the invoice to detect potential bases for disputing the invoice, presenting the invoice to a manager associated with the customer, wherein the presentation identifies potential bases for disputing the invoice as determined by auditing the invoice, determining whether the manager desires to dispute at least a portion of the invoice, and when the manager indicates a desire to dispute at least a portion of the invoice, obtaining from the manager information defining the disputed portion of the invoice and communicating this information to a provider responsible for the invoice.

In another form, the present invention may be embodied in computer readable media tangibly embodying instructions, which when executed by a computer, implement a process comprising the steps of receiving an invoice from a provider, auditing the invoice to identify values likely to be disputed, presenting the invoice to a manager, wherein the presentation identifies values likely to be disputed, querying the manager to determine whether the manager desires to dispute presented values, and when it is determining that the manager desires to dispute a presented value, assisting the manager in disputing the presented value.

### BRIEF DESCRIPTION OF THE FIGURES

FIG. 1 illustrates the components of a system for providing an invoice management system according to the present invention.

FIG. 2 illustrates a basic process for implementing the present invoice management invention.

FIG. 3 illustrates a basic process for acquiring invoices as may be implemented with the present invoice management invention.

FIG. 4 illustrates a basic process for automated review of invoices received as may be implemented with the present invoice management invention.

FIG. 5 illustrates a notional navigation screen for allowing a manager to navigate within an invoice management system according to the present invention.

FIG. 6 illustrates a basic process for displaying invoice information to a manager as may be implemented with the present invoice management invention.

FIG. 7 illustrates a notional invoice presentment interface as may be implemented with the present invoice management invention.

FIG. 8 illustrates a basic process for assisting a manager in generating a dispute of an element of an invoice as may be implemented with the present invoice management invention.

FIG. 9 illustrates a notional dispute generation template as may be displayed to a manager to assist in the generation of a dispute as may be implemented with the present invoice management invention.

FIG. 10 illustrates a basic process for assisting a manager in paying an invoice as may be implemented with the present invoice management invention.

FIG. 11 illustrates a notional payment approval template as may be displayed to a manager to assist in the approval of payment of an invoice as may be implemented with the present invoice management invention.

FIG. 12 illustrates a notional direct payment template as may be displayed to a manager to assist in the direct payment of an invoice as may be implemented with the present invoice management invention.

FIG. 13 illustrates a notional process for enrolling new clients to an invoice management system with the present invoice management invention.

FIG. 14 illustrates a notional process for a manager to request association of additional accounts with an existing manager account with the present invoice management invention.

FIG. 15 illustrates a notional new account association template as may be displayed to a manager to assist in the acquisition of new account information as may be implemented with the present invoice management invention.

FIG. 16 illustrates a new provider template as may be displayed to a manager to assist in the acquisition of information pertaining to a new supplier or provider.

FIG. 17 illustrates a notional property information template.

FIG. 18 illustrates a notional account management display allowing accounts associated with a client to be administered.

FIG. 19 illustrates a notional template for editing memory contact information as may be implemented with the national account management display of FIG. 8.

FIG. 20 illustrates a conceptual process which may be implemented when accounts are disassociated from the existing client associated with the invoice management system.

FIG. 21 illustrates a notional database structure associated with the present invention, illustrating potential groupings of data.

FIG. 22 illustrates a notional group bill illustrating aggregation of invoices for multiple providers associated with a single client.

### DETAILED DESCRIPTION OF THE INVENTION

The present invention is centered around an invoice management system supportive of managers who are responsible for determining whether an invoice should be paid. As shown in the Figures, wherein like numbers represent like elements, the invoice management system may be embodied in an invoice management center, a process for providing an invoice management system to managers, or embodied in software for a system for providing an invoice management system for managers.

### Invoice Management System

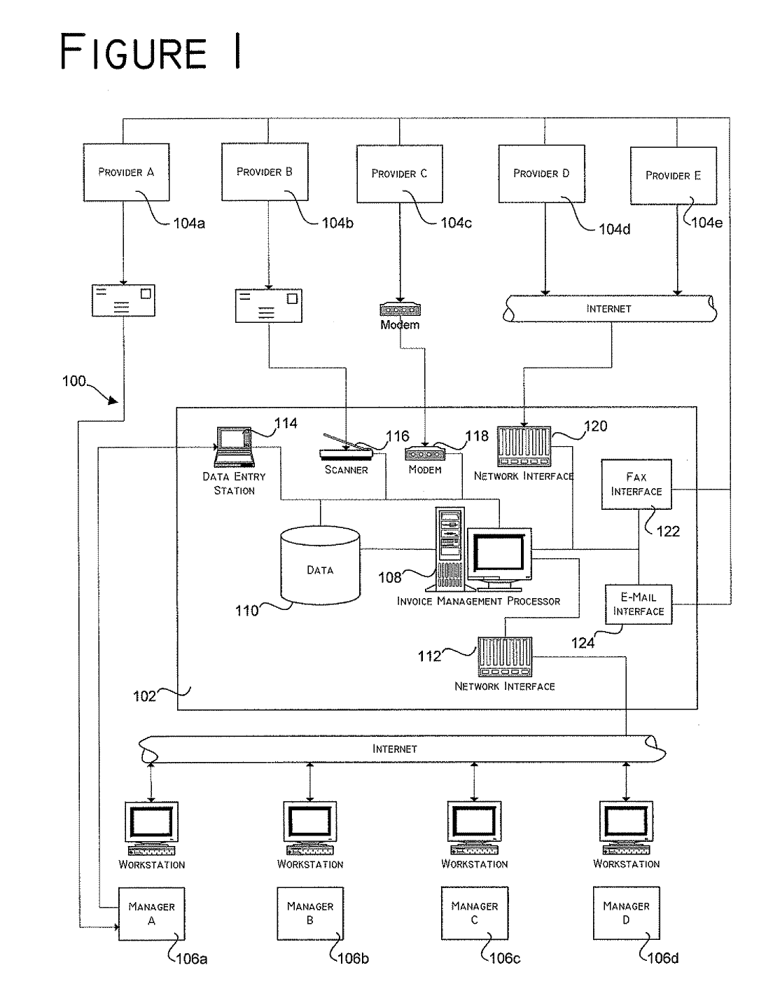

As shown in FIG. 1, an invoice management system 100 may be formed by communicably connecting an invoice management center 102 with providers 104a, 104b and managers 106a, 106b. The invoice management center 102 may include an invoice management processor 108, a database 110, a network interface 112 for communicating via a network with managers 106a, 106b, and various types of interfaces 114, 116, 118, 120 for communicating with providers. The invoice management system 100 may further comprise a database 110 for storing information received from providers 104a, 104b, information associated with the management of invoices, and information associated with disputed elements of invoices. As noted, the term managers includes, but is not limited to, all entities responsible for the payment of bills for services or resources received. Although the efficiency of the system is most suitable for managers responsible for multiple accounts, the system may be utilized for managers of single accounts. Additionally, the system may be implemented to accommodate multiple managers with varying authorities for a single client, including third party agents returned by the client to manage accounts for the client, as well as to accommodate agents managing accounts for third part account owners.

The invoice management processor 108 may be a single processor, or a group of processors selected to handle specific tasks associated with the invoice management center 102. For example, one processor may be used to manage received invoices, while another processor is used to generate information displays for managers. Alternately, multiple processors may be utilized for individual functions to provide necessary processing capability. For example, several processors may be utilized to generate information displays for managers, allowing the speed with which displays can be generated to be adjusted based on demand of managers to view displays.

The various types of interfaces 114, 116, 118, 120 for communicating with providers may be selected based on the format of information that is to be received from the providers. If invoices are to be provided in hard copy format, an operator with a data entry terminal 114 may be included to allow manual entry of information from invoices. Alternately, if the invoices are to be received in hard copy format, a scanner 116 having format and character recognition software may be implemented. Since it is necessary for information contained on an invoice to be characterized both as to value and as to what the value represents, the ability of software associated with the scanning process to recognize an invoice format removes manual intervention to associate values with what the value represents. Such a function may be accomplished by using templates based on invoice formats. Such templates identify where on an invoice particular data elements are located, allowing values located at particular locations to be associated with what the value represents.

Alternately, where a provider is willing to provide invoices in an electronic format, a modem 118 or network interface 120 may be provided for receiving the electronic invoices. The electronic invoices may be transmitted from the provider to the invoice management center 102 in a known format, again allowing the invoice management center 102 to associate values with what each value represents. For example, one field may represent a total cubic footage of natural gas used, in thousands of cubic feet. By understanding that the value in the field represents thousands of cubic feet of gas used, further processing can be performed on the value. Associations with values, such as a value with cubic feet of natural gas used, may be forwarded from a provider in a text format, if the invoice management center has foreknowledge of the format, or in a tagged field format identifying the characterization of the value in association with the value.

The database 110 of the invoice management system 100 may be used to contain account information to be associated with an invoice, invoice information itself, historic invoice information, and information associated with the invoice management system 100, to allow assessment of fees associated with the invoice management system, 100.

The invoice management center 102 may further be provided with elements to allow disputed invoices to be communicated to providers. For example, where a particular invoice identifies a large use of electricity, and where the manager responsible for the invoice knows that the building was unoccupied, the invoice management center may assist the manager in disputing the electricity usage information with the provider by using an interface 122 to generate a facsimile transmission identifying the disputed elements to the provider, or by using an e-mail interface 124 to generate an e-mail identifying the disputed elements to the provider.

### Basic Process

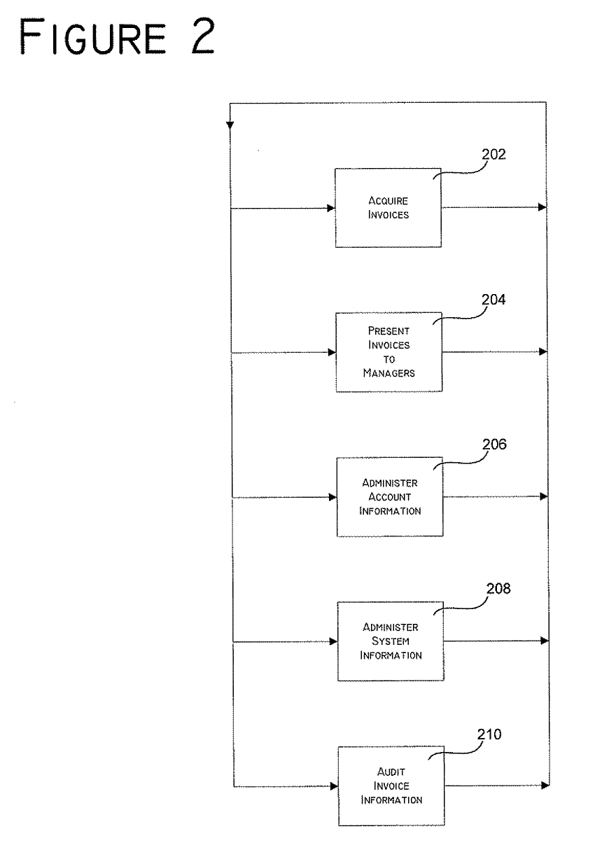

As shown in FIG. 2, the basic process of the present invention includes sub-processes for acquiring invoices 202, presenting invoices to managers 204, administering account information 206 associated with invoices, and administering system information. Each of these processes are discussed in further detail below. The process is preferably operated in a continuous function, wherein each sub-process is concurrently running to allow invoice management to be available without delays while other sub-processes are accomplished.

The basic process may further incorporate a step for auditing invoice information 210 to suggest when information contained on an invoice is susceptible to dispute. As discussed further below, the audit process may be a discrete step in the basic process, or may be incorporated into the step of presenting invoices 204 to a manager.

### Invoice Intake

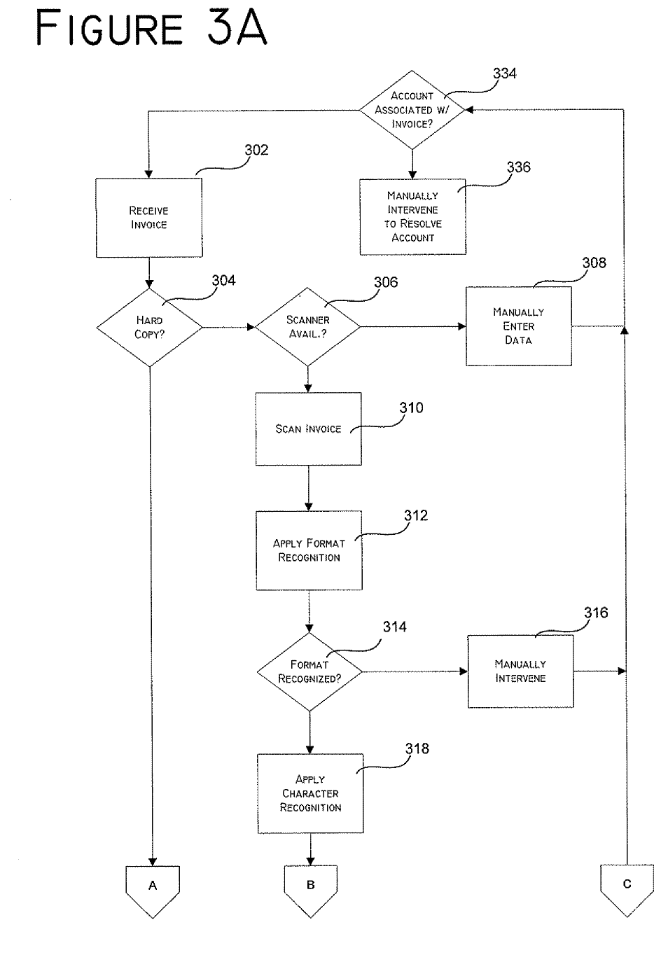

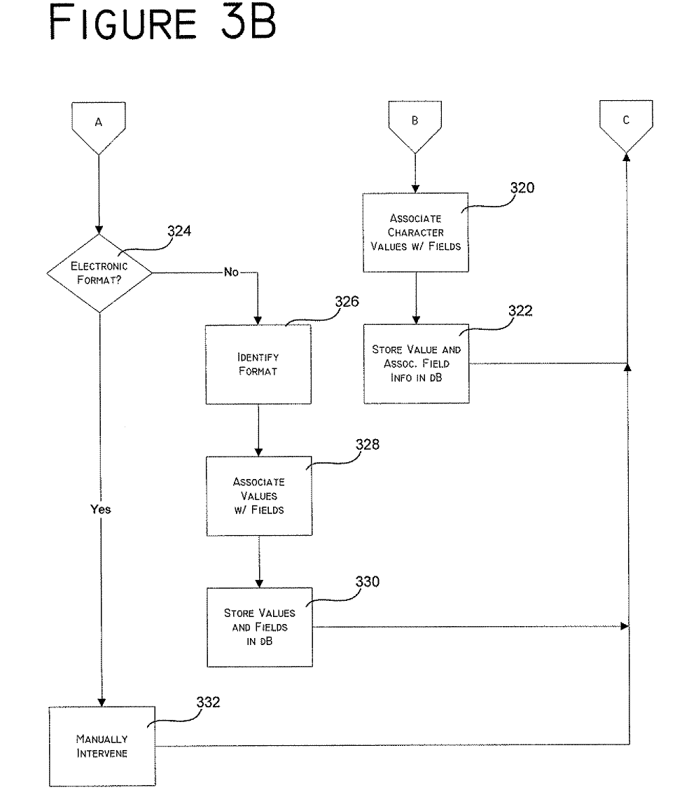

As shown in FIG. 3, the step of acquiring invoice information may be handled in varying fashions dependant upon the form of the invoice. Where a provider responsible for providing services such as gas, electricity, steam, or any other commodity, including labor services, generates an invoice for the services, the invoice may take different forms. In a least integrated mode, the invoices may be received via hard copy, such as through the mailing of an invoice. Such an invoice could be mailed either directly to the invoice management 102 center, or forwarded by a manager to the invoice management center 102. Once the invoice is received at the invoice management center 102, the data contained on the invoice must be converted to a digital form, allowing incorporation of the data into a database containing invoice information. The data may be converted to a digital form either by an operator manually entering the data into a computer, or by the invoice being scanned and converted to digital data. Scanning may be accomplished through the use of recognition templates based on expected invoice bill formats to reduce complexity in correctly identifying values and what they represent. Utilization of formats requires prior knowledge of the format of invoices. Accordingly, changes in invoice format must be noted by the invoice management system, to prevent erroneous digitalization of data from invoices.

Once an invoice is received 302, the process may determine 304 whether the invoice is a hard copy or paper invoice. If the invoice is a hard copy, the process may determine 306 whether a scanner is available for converting the invoice to digital information. If no scanner is available, the invoice may be forwarded to a data entry entity for manual entry 308 of information contained on the invoice into a database associated with the process. If a scanner is available, the invoice may be scanned 310. Format recognition capability may be applied 312 to determine the format or layout of the invoice. Different providers may provide invoices in different layouts. Each layout may use a different locations or fields on the invoice for individual values, such as for an electric bill, which could contain information quantifying amount of electricity used, cost per unit of the electricity used, and total cost for electricity used for the period covered by the invoice. By detecting or knowing where these fields are contained on the invoice, the scanned information can be parsed so that characters in the fields indicating specific values can be scanned for character recognition to determine the values. Layout recognition software may use either specific positioning information or the presence of specific header information to locate a field associated with a specific value. Specific header information may include text identifying the field for a specific value, where the field has a variable position on an invoice. If the layout can not be recognized 314, the invoice may be forwarded for manual intervention 310. Such manual intervention 316 may result in manual entry of the information contained in the invoice, as well as updating of the layout recognition software to accommodate a new invoice layout.

Once fields have been identified, character recognition capabilities may be applied 318 to the characters contained in a specific field to associate 320 the value of the characters contained in the field. The values and the field with which the value is associated may then be stored 322 for later processing.

When it is detected 324 that an invoice has been received in an electronic format, such as via a modem or network interface, the format of the invoice may be identified 326. Detecting the format of the invoice may be accomplished by searching the received information for specific character strings, filed headers, or file name extensions. Once the format of the electronic invoice has been identified 326, values contained within the invoice may be associated 328 with requisite fields, and stored 330 for later processing.

Detection of format changes may alternately be implemented through notification from the bill issuer. Such notification would depend on the bill issuer's willingness to provide advance information regarding bill formats to the bill management system. Should a provider inform the invoice management system of a new invoice format, the system could be updated to recognize the new format based on the information provided, whether the format was hard copy or electronic.

If the invoice is received in a format which can not be identified, manual intervention 332 may be applied to determine why the invoice was not able to be automatically taken in. Such manual intervention 332 may result in updates to the automated intake of invoices, such as through a scanner or through electronic intake, as well as manual data entry of information contained on the invoice.

The intake of invoices may further include testing 334 to determine whether an account to which the invoice should be associated exists. If an invoice were improperly forwarded to the invoice management system, such as when a provider improperly forwards the invoice, manual instruction 336 should occur, such, for example resulting in the provider being notified that the invoice was improperly forwarded. Alternately and additionally, information associated with the invoice may be stored such that the correct recipient of the invoice may be informed of the availability of the invoice management system.

Finally, forwarding of invoices to the invoice management system may be accomplished either by an indirect path, or via direct transmission of the invoice from the provider to the invoice management center. Where invoices are forwarded to managers, the manager could retransmit the invoice to the invoice management system for intake into the invoice management system. Such an indirection incorporates an inefficiency in that a transmission lag is incurred by the forwarding process, which may reduce an available grace period for responding to the invoice. Direct transmission of the invoice from the provider to the invoice management system obviates such delay, and may be arranged between the manager and the provider, or arranged for the manager by the provider when a manager subscribes to have invoices addressed by the invoice management system.

### Invoice Auditing

Auditing of invoices may be accomplished when invoices are received, when invoices are viewed, or at such other time determined to be efficient for the operation of the bill payment service. The generation of audit information upon receipt of an invoice fixes the audit rate to the input rate, allowing some measure of control over the processing requirements associated with the audit function. The generation of audit information at the time of display of an invoice for a manager allows audit analysis to encompass up to date criteria, should a manager have modified criteria immediately prior to viewing an invoice. Alternate times may be used, such as where the audit analysis is performed by the same server providing other functions, as a means of moving processing requirements to off peak times for the server.

Audit rules may be based on three categories of analysis. The first category involves comparing a present invoice to a second invoice, such as the preceding months, the same month from the previous year, or any other month for which comparison is desired. The second category is comparing an invoice, or values contained within an invoice, to general parameters. For example, the billing rate for a service may be compared to billing rates for other service providers, or a usage rate may be normalized based on external parameters, such as an average monthly temperature on the number of days covered by the invoice. The other static criteria, such as verification of the correct client number associated with the invoice, may be implemented as well. The third category includes comparison of the present invoice to statistical information derived by the bill payment service, such as the rate at which invoices from a provider are disputed.

Month to month analysis may employ percent change calculations between values on the respective invoices, along with a threshold percentage outside of which a review flag may be set. For example, if a December 2002 invoice exhibited a 12% increase over the December 2001 invoice, and a threshold of 10% difference had been set, a review flag could be set for the usage exhibited on the December 2002 invoice.

Invoice to external data analysis may encompass comparison of invoice data to external information, such as average rates for a given geographic region associated with a property. External data analysis may also include normalization of invoice data to external data, such as weather conditions that could vary heat consumption parameters.

Statistical data provides an audit capability typically not found in bill payment systems proffered by utility providers. The use of error rate information in setting review flags highlights problem areas with individual service providers, such that review flags inform a manager of the accuracy of billing provided by a specific supplier. Alternately, the statistical data could be based on monitoring methods used for usage quantity monitoring. For example, where a specific model of monitoring equipment has a high rate of disputed charges, the manager could be informed of the high dispute rate associated with the equipment, allowing the manager to request improved monitoring equipment.

The criteria used for auditing may be stored in a database separate from invoice information. Audit criteria could be further segregated within the database based on the source of the criteria. For example, one group of criteria could be associated with service providers, such that access to the data would be restricted to personnel associated with the payment service. Month to month review flag criteria could be stored so as to be accessible to users, while external references such as average provider rates could be provided by providers, determined from examination of received invoices, or provided by a third party monitoring service.

The audit process may furthermore be implemented through an expert system, wherein the applied rules use the criteria to better identify elements on an invoice for which review is recommended.

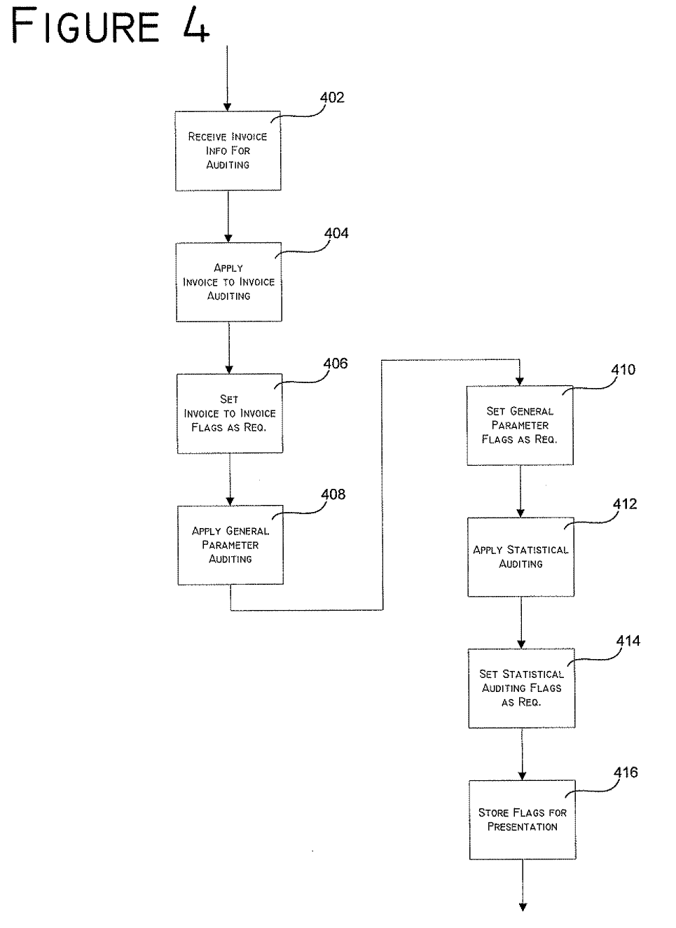

Application of an auditing process is shown in FIG. 4. As the auditing process may be accomplished in a general invoice management processor, or in a separate processor associated with the invoice management system, the auditing process begins with invoice information being received 402 by the processor responsible for auditing the information. Invoice to invoice auditing may then be applied 404 to the invoice information. The invoice to invoice auditing may involve queries to a database to determine historical information associated with an invoice. The invoice to invoice auditing process may result in values being determined to be susceptible to dispute, at which point flags identifying the value as being susceptible for dispute may be set 406 for later presentation to a manager.

After invoice to invoice auditing has been applied, general parameter auditing may be applied 408. The general parameter auditing may invoke queries to a database to determine parameters set by a manager for a bill, such as a budget for monthly usage. The general parameter auditing process may result in values being determined to be susceptible to dispute, at which point flags identifying the value as being susceptible for dispute may be set 410 for later presentation to a manager.

After general parameter auditing has been applied, statistical auditing may be applied 412. The statistical auditing may invoke queries to a database to determine statistical information associated with an invoice, such as whether equipment utilized to obtain billing information has a high rate of being disputed. The statistical auditing process may result in values being determined to be susceptible to dispute, at which point flags identifying the value as being susceptible for dispute may be set 414 for later presentation to a manager.

Once all auditing processes have been accomplished, any flags that have been set may be stored 416 in a database for later presentation, or for later use in deriving statistical information regarding invoices.

### Invoice Presentment

Invoice presentment is the core of the present system, in that proper presentment of data to a manager allows the manager to more effectively manage invoices. In one embodiment, the information may be presented in a graphical form consistent with the appearance of a normal paper bill which would have been received by a manager if the bill payment system was not being used. Alternately, a custom display form standardizing information presentation from multiple providers may be used. Finally, both appearances could be provided for managers, with the managers able to choose a personally preferred appearance.

The information visually presented to a manager may preferably include embedded links within the display, such that associated elements may be selected to obtain further information. The further information may be based on explanations of the item itself, or of historical information associated with the value. Each piece of information which can be disputed may have a dispute button associated therewith, such that clicking the dispute button initiates the dispute process for that element. An invoice payment button may also be provided, such that activation of the bill payment button initiates a process for assisting the manager in paying an invoice, such as by generating a message to an accounting function that the invoice is approved for payment, or by generating an electronic funds transfer in satisfaction of an invoice. These processes are discussed further below. Other elements on the display may have her alternate actions, such as pull down menus to allow the editing of criteria associated with a value, explanation windows for review flags, or detail information associated with a property identifier or contact.

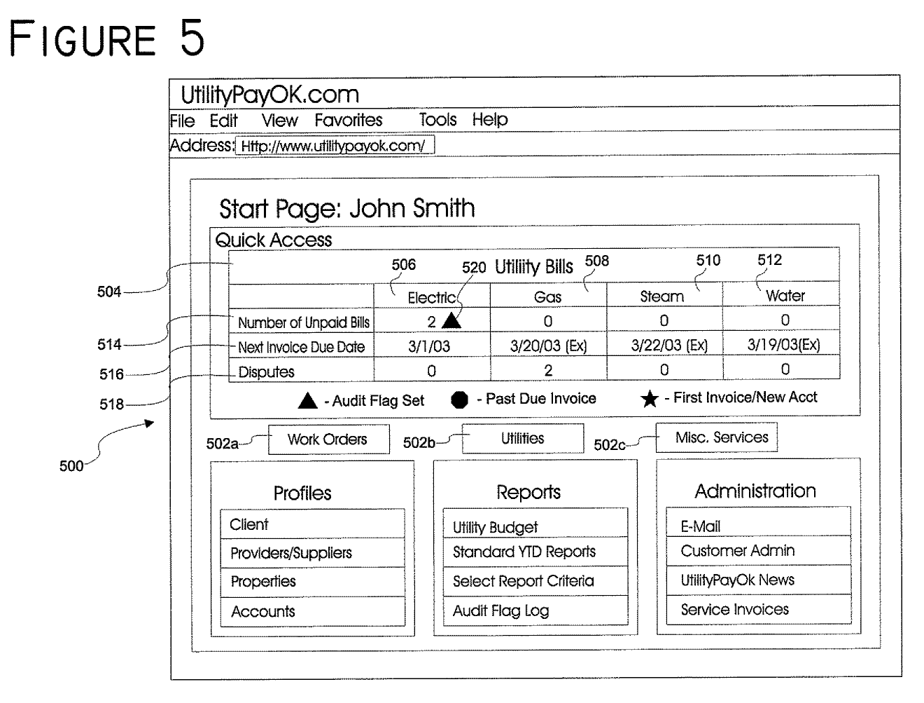

A main page 500 as shown in FIG. 5 may be provided to allow a manager to navigate within the services associated with the invoice management system. The main page display 500 may have invoice type selection buttons 502a, 502b, 502c to allow selection of invoice types. The main page display 500 is shown with utility invoices shown, as if the utilities selection button 502b had been selected. A quick access display 504 may be provided to provide principal information, such as sub-types within an invoice transaction type. For example, for a utilities quick access display 504, sub-types may include electric 506, gas 508, steam 510, and water 512. These examples are illustrative, and are not intended to limit the invoice types or sub-types in any way.

Within the utilities quick access display 504, categorical information such as “Number of Unpaid Invoices” 514, “Next Invoice Due Date” 516, or “outstanding disputes” 518 may be displayed for a manager. Additionally, information associated with presented data may be included, such as, but not limited to, presentation of an icon to indicate the presence of un-addressed audit flags 520 associated with invoices.

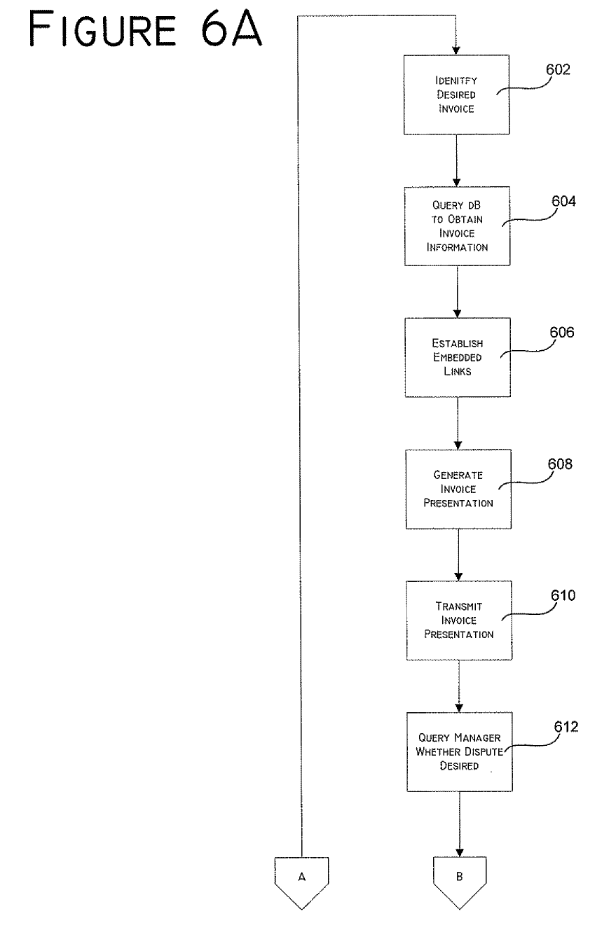

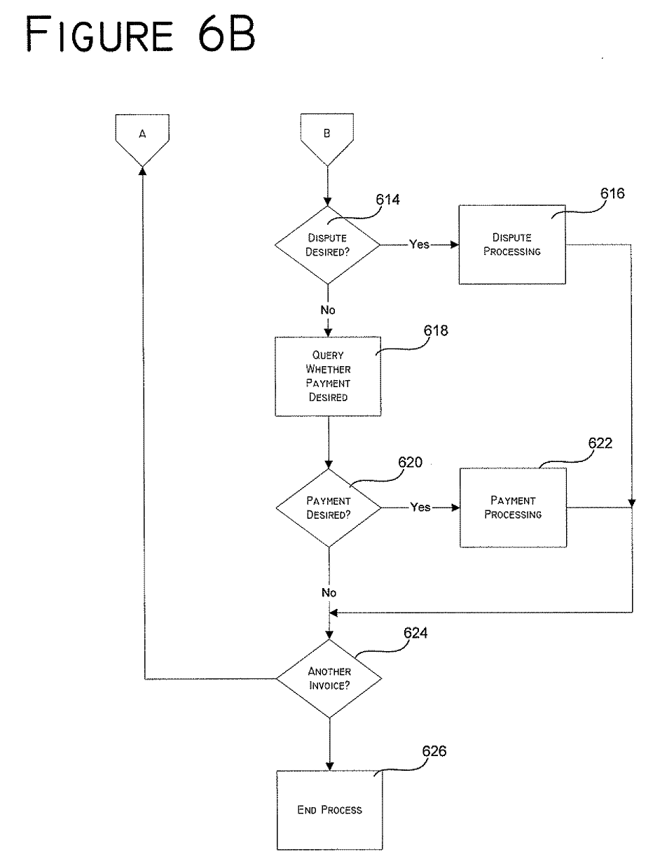

The basic process of invoice presentment is shown in FIG. 6. The process begins by a manager identifying 602 an invoice to view. Invoices available for viewing may be displayed in a menu for a manager, such that each invoice associated with that manager is shown on a menu. Selection of a menu item may initiate display of that invoice.

Once an invoice has been identified, the system may query 604 a database to obtain the invoice information. The invoice information may include a presentation format, such as a layout associated with a provider or a layout otherwise defined as the default presentation layout by the manager, as well as invoice information, and flags associated with an invoice. As noted above, the auditing process may be a sub-function within the step of querying the database to obtain relevant information, or may have been previously run. Links embedded within the displayed invoice may be established 606. Such links may include explanations associated with flags, references to information associated with a value or parameter, or any other link desired to be embedded within the presentation.

The invoice presentation may then be generated 608. The invoice presentation may be generated in a format which is communicable over the connection used between the invoice management system and a manager using the system. Typically, where the Internet is utilized for the communications connection, the format may utilize html (hyper text mark-up language), .xml, xml (extensible mark-up language), or any format compatible with a network access device being utilized by a manager. Alternately, specific software may be utilized allowing a manager to use a modem to connect to and access the system. Additionally, various security measures may be employed, such as encryption of data to be transmitted, to ensure the security of information contained in the presentation. Once generated, the invoice presentation may be transmitted 610 to the manager.

The manager may be queried 612 to determine whether the manager desires to dispute a displayed invoice or a portion of a displayed invoice. Such a query may be accomplished through display of a “dispute” button associated with values shown on the presented display, or by display of a specific question asking the manager whether he or she desires to dispute an invoice or portion of an invoice. The dispute process is discussed further below. It is determined 614 that if the manager indicates a desire to dispute an invoice or a portion of an invoice, a dispute process may be initiated.

The manager may also be queried 618 to determine whether the manager desires to pay a bill, or approve a bill for payment. If it is determined 620 the manager desires to pay an invoice, a payment process may be initiated 622 discussed further below.

Once the manager is finished with the presented invoice, it may be determined whether the manager desires to view another invoice. If the manager desires to view another invoice, the process may be restarted. It is determined 624 that if the manager does not desire to view another invoice, the process may be terminated 626.

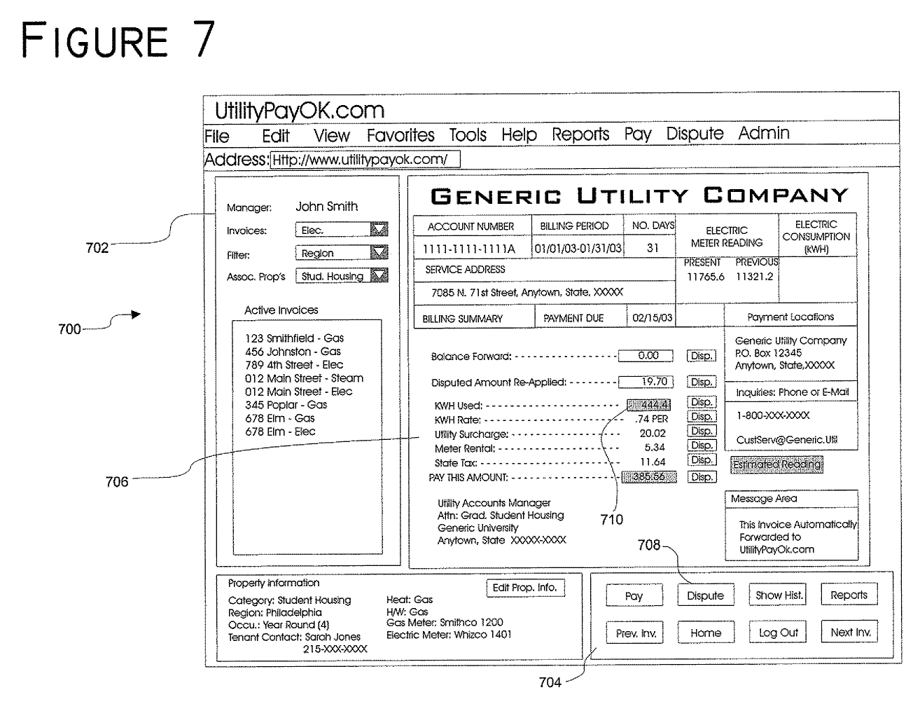

FIG. 7 shows a notional invoice presentation 700. The presentation may include navigation windows 702, 704 and/or displays to allow a manager to access information related to a particular invoice, as well as a representation 706 of the invoice itself. The invoice may be presented as would be seen if viewing a paper copy of the invoice, to provide a familiar presentation to the manager. A means for initiating a dispute 708 for elements of the invoice may also be provided. For the purposes of the present discussion, dispute initiation button 708 is shown, although dispute initiation could be enabled through hyperlinks associated with the text describing the element, hyperlinks associated with the element itself, a master dispute initiation button which could then prompt for identification of what element the manager wanted to dispute, or any other method known in the art. Items flagged 710 for attention through the audit process may be highlighted or use a color change to provide an indication to the manager of the status of the element. For example, the kWh Used element is shown in a highlighted box to indicate that auditing of the invoice raised a question with regard to the amount. The highlighted element may be hyperlinked to a drill down display providing further information regarding why the element was highlighted, such that the manager could consider the reason why the element was highlighted before deciding whether to dispute the amount.

### Dispute Process

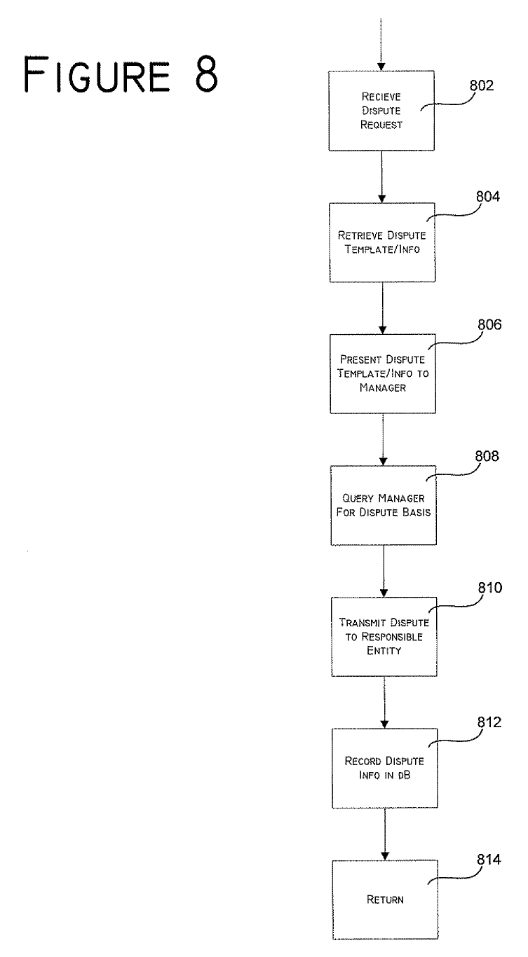

The bill dispute process, for which a notional flow chart is shown in FIG. 8, allows a manager to receive assistance in disputing an invoice or a portion of an invoice. For example, where an electrical bill is received for a property, and the amount of the bill is excessive relative to the previous months utilization, the manager may desire to dispute the bill, and have the contained information verified. Such verification may include a second reading of a meter associated with an amount shown on an invoice, or a challenge to any other aspect of the amount. Providers typically have a specific required method for disputing amounts. These methods may be mandated by local rules. As an example, a disputed amount may not be considered due and payable while in dispute. In order to dispute an amount, a manager may be required to provide notification to a specific entity that the amount is disputed, and a short reasoning for the dispute to prevent disputes from being improperly raised. In order to generate a dispute, a message to a relevant entity must be generated. Such a dispute may be generated as a function of the invoice management system through generation of an e-mail transmission or other transmission to the responsible entity from the manager. Accordingly, where a manager desires to dispute an amount, the invoice management system may receive 802 a dispute request and retrieve 804 from a database information identifying the responsible entity for receiving the dispute, as well as a template of information required. The template may be presented 806 to the manager, and the manager queried 808 to provide required information, such as the basis for the dispute. Stored information, such as the responsible entity for receiving the dispute, may be provided with the template to reduce the amount of information required from the manager. Furthermore, where the manager indicates that an individual amount is desired to be disputed, the template may be automatically provided with information identifying the disputed amount, again reducing the involvement required of the manager. Once all information has been provided, the dispute information may be transmitted 810 to the responsible entity. Information associated with the dispute may be recorded 812 in a database to allow the manager to track the dispute, and monitor its resolution. Where a disputed amount is re-billed on a following invoice, the information may be flagged for the manager's attention, to determine whether the dispute was resolved to the manager's approval. Once the dispute has been recorded, the process may terminate, and return 814 the manager to the invoice screen.

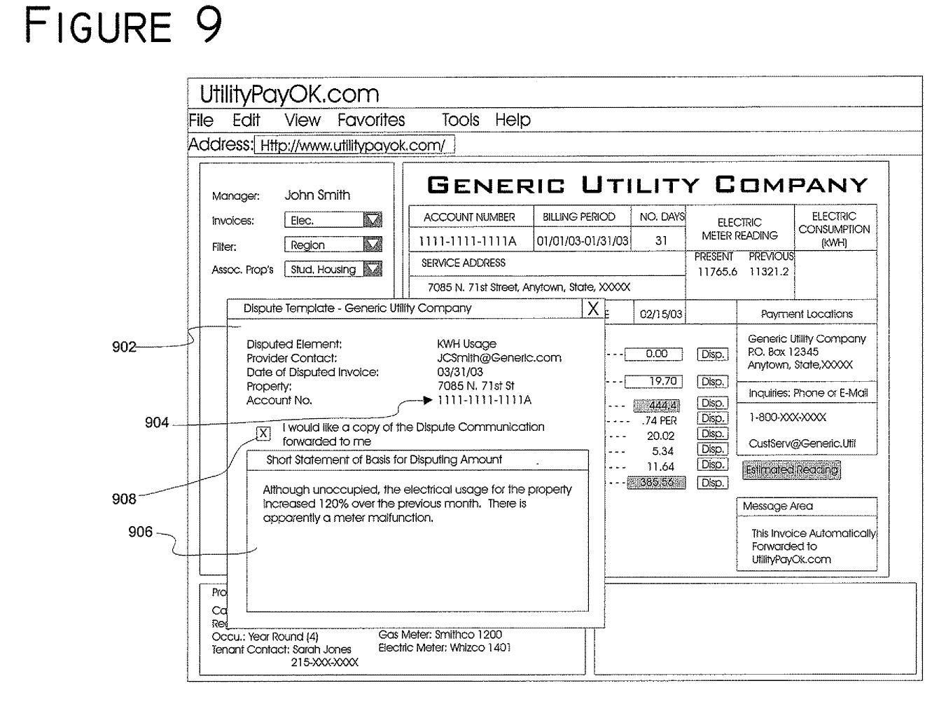

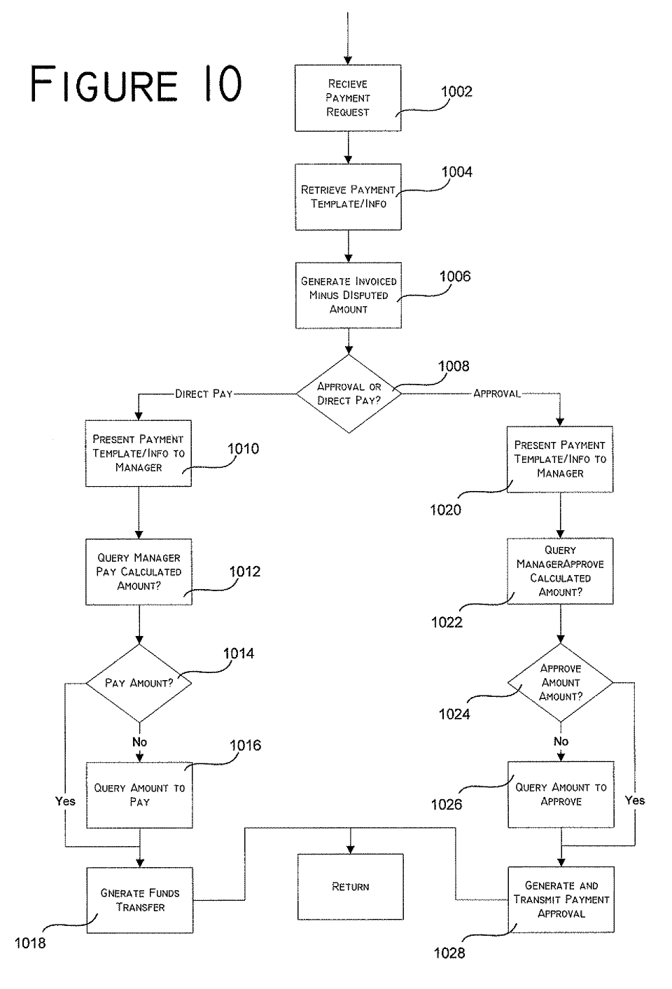

A notional dispute template 902 is shown in FIG. 9. As shown, the dispute presentation may be a pop-up window overlaid onto the invoice presentation. Alternately, but not limiting the potential displays, the dispute presentation may comprise its own display, however the use of windowing allows a manager to rapidly switch between the dispute presentation and other displays, allowing the manager to more effectively manage the presented information. The dispute presentation may automatically provide information associated with the dispute, such as the account number 904 for the invoice bearing the disputed element. Other information which may assist in or be required for the dispute process may also be automatically presented. The dispute presentation may provide a text box to allow a manager to provide a short statement 906 of the basis for the dispute. Additional features, show as the ability to automatically forward 908 a copy of the dispute communication to the sender, may be implemented as desired.

### Payment Process

A manager may alternately be provided with automated capabilities for approving or generating payment on an invoice when it is so desired. Managers may typically either forward an invoice as approved for payment, or generate a payment for the invoice themselves. Where an invoice is to be forwarded, a template may be utilized to query requested information from the manager before forwarding the information to the next responsible individual. Such a template may utilize pre-stored information to identify elements of the approval required, such as who the next responsible individual is, their contact information, and/or a form of transmission for the approval.

Where a payment is to be made by the manager, the invoice management system may implement functionality for generating an automated payment, such as through an electronic funds transfer to the provider, or by automated generation of a check paying an invoice, for the manager.

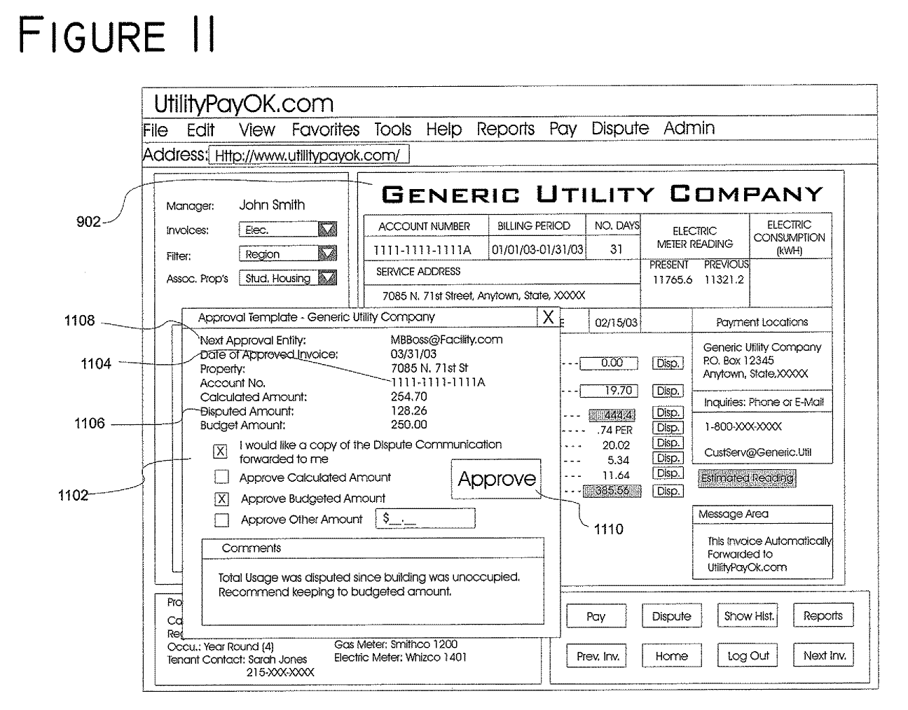

As shown in FIG. 10, the process for paying an invoice may begin when the invoice management system receives 1002 a desire to make a payment. The invoice management system may query a database to retrieve 1004 information associated with the payment process, such as the manager's preferences for making the payment, and/or payment style, such as through an approval forwarded to another responsible entity, or through automated generation of a payment. The corrected invoice amount may be calculated 1006 to display for the manager the amount due on the invoice after disputed amounts have been subtracted. If it is determined 1008 that approval forwarding is indicated for a payment, the invoice management system may display 1010 an approval template for generating the approval. As noted above, information for completing the template may be retrieved, including but not limited to, the identity of the next responsible entity, preferred transmission method, and information identifying the invoice may be automatically populated on the template to reduce the amount of information required to be provided by the manager. The approval template may then be displayed for the manager, and the manager queried 1012 to provide any additional required information. The manager may also be queried to determine 1014 whether the manager desires to approve the calculated invoice amount. If the manager indicates a desire not to pay the calculated invoice amount, the manager may be queried 1016 to determine the amount that the manager desires to approve. Once the amount has been determined, the invoice management system may generate 1018 a payment approval communication, in a format as previously identified, such as through generation of an electronic mail communication. Alternately, where the next step on the approval cycle also addresses the invoice via the invoice management system, a prompt to the responsible individual for the next step on the approval cycle (including actual payment of the invoice) may be communicated through the system. Additionally, where desired, automated carbon copies of any communications may be forwarded as indicated to ensure that all relevant parties are kept informed of the handling of the invoice.

Where the payment style is direct payment authorized by the manager, the invoice management system may implement a process similar to the approval process. Once calculated amount has been determined, a payment template may be generated and displayed 1020 for the manager. The manager may be queried 1022 as to whether the manager desires to pay the calculated amount. If the manager indicates a desire 1024 to pay an amount other than the calculated amount (such as an averaged amount associated with the invoice), the system may query 1026 the manager to identify the desired amount to be paid. A funds transfer then may be generated 1028. The funds transfer may be accomplished through electronic transfer of funds to the provider, by the generation of a paper check for transmission to the provider, or by any other means desired by the manager. The invoice management system may be configured to provide automated check generation and forwarding if desired. Such automated check generation would entail the provision of a printer capable of printing checks for the manager, and merging the check with an envelope and printed payment coupon generated by the invoice management system, allowing the manager to operate in a paperless environment where the provider still requires paper transmission of payments.

Although the above discussion treats disputing and payment as discrete processes, it is possible that only a portion of an invoice is to be disputed, with the remainder to be paid. In such a situation, elements of an invoice marked as to be disputed may be withheld from a payment amount where a portion of an invoice is to be disputed, with the non-disputed portion providing the total amount of any payment to be made.

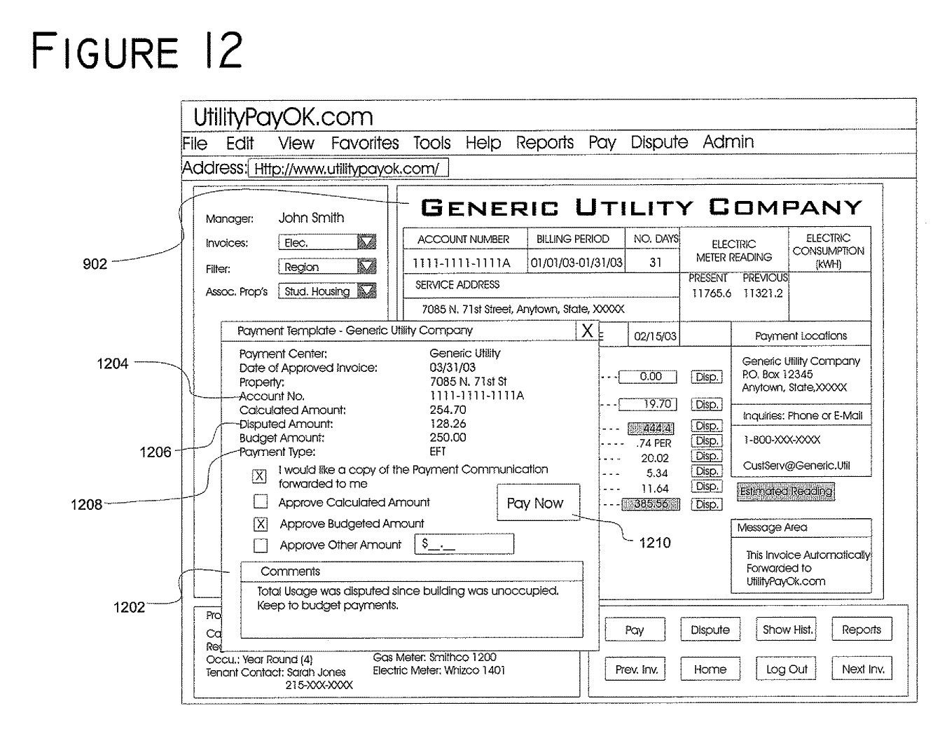

FIG. 11 illustrates a notional approval template 1102 for forwarding an approval. As shown, the approval template 1102 may be a pop-up window overlaid onto the invoice presentation 902. Alternately, but not limiting the potential displays, the approval template may comprise its own display, however the use of windowing allows a manager to rapidly switch between the approval template and other displays, allowing the manager to more effectively manage the presented information. The approval template may automatically provide information associated with the approval, such as the account number 1104 for the invoice being approved, identification of disputed amounts 1106, and identification of the next responsible entity 1108 in the approval cycle. The template may also have a feature 1110 allowing a manager to indicate a desire to complete an approval.

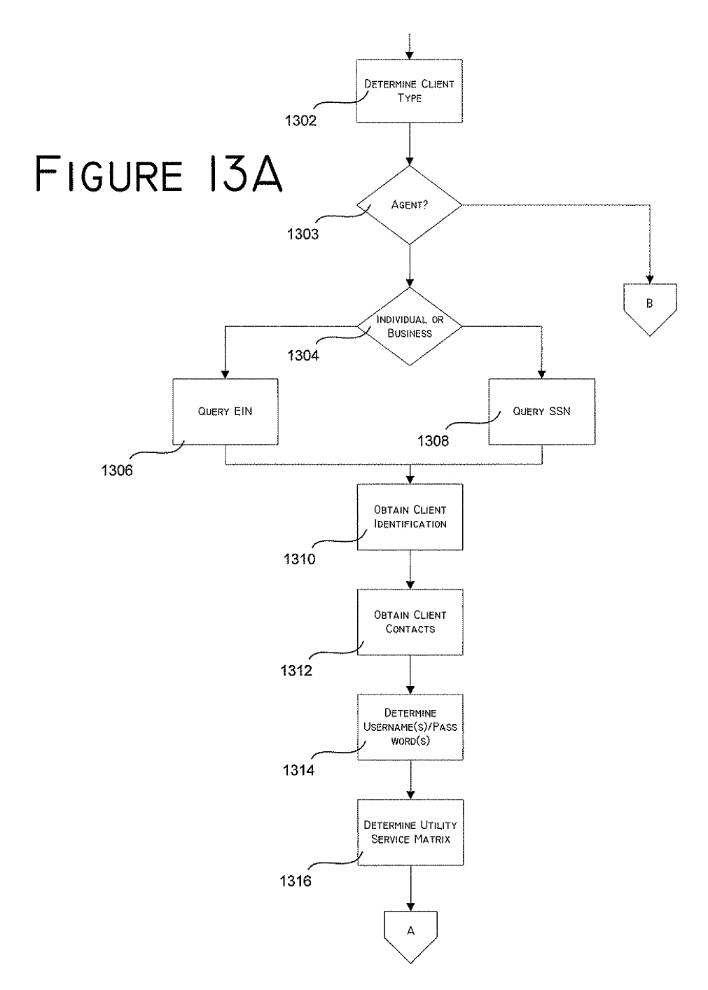

FIG. 12 illustrates a notional payment template 1202 for paying the non-disputed portion of an invoice. As shown, the payment template 1202 may be a pop-up window overlaid onto the invoice presentation. Alternately, but not limiting the potential displays, the payment template 1202 may comprise its own display, however the use of windowing allows a manager to rapidly switch between the payment template 1202 and other displays, allowing the manager to more effectively manage the presented information. The payment template 1202 may automatically provide information associated with the payment, such as the account number 1204 for the invoice being approved, identification 1206 of disputed amounts, and identification of default payment style 1208. The template 1202 may also have a feature 1210 allowing a manager to indicate a desire to complete a payment.

### Enrollment

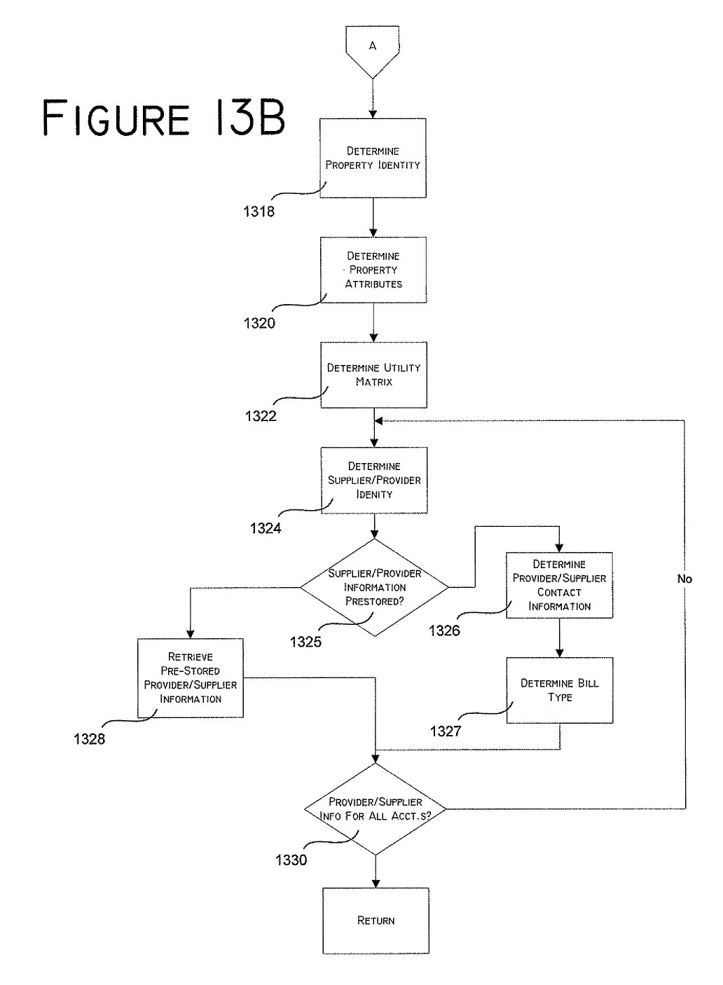

Enrollment of new clients to a service operating the invoice management center can be accomplished either through manual intervention or through an automated interface associated with the invoice management system. A process for enrolling a new client is shown in FIG. 13. As some means of identifying individual clients may be required, a unique client number may be created, or a pre-existing number associated with the client may be use. As tax numbers are becoming the common identifier, the use of tax numbers may be implemented to provide a unique identifier associated with a client. The first step, assuming the use of tax numbers as unique identifiers, is to determine 1302 the entity type of the client. If the client is a business, the business will have an employer ID number (“EIN”), while if the client is an individual, the client may have a social security number. If it is determined 1304 that the client is a business, the client may be queried 1306 to obtain the EIN. If the client is an individual, the client may be queried 1308 to obtain the individual's social security number. Once an identifier for the client has been obtained, contact information for the client may be obtained 1311. Next, usernames and/or passwords to control access to client related information may be obtained 1314 from the client, or assigned to the client. The client may be queried 1316 to determine the range of provider types that will be associated with the client. For example, a residential property that is a client's only property for which accounts will be managed may have only gas and electricity associated with the property. Conversely, a different client may desire to manage buildings which have steam service, as well as water, gas, and electrical service. By identifying the provider types, displays for a manager may be populated to show only relevant provider types for navigational purposes. Once the provider types have been determined, the properties to be managed may be identified 1318. Although the term “properties” is used here, the present invention may be adapted to provide improvements for managing accounts whether the accounts are organized by property or by any other classification. Since property attributes may be used to provide information for the manager, property attributes may next be determined 1320. The attributes may be used for reporting purposes, as a factor in auditing decisions, or to allow cross referencing between properties by a manager (i.e., to allow the manager to search for all properties having a specific attribute). A list of providers which may be associated with a property provides a matrix of provider types. Determination 1322 of the matrix allows a client to be queried to identify each provider. The identity of card relevant provider may then be determined 1324. For each provider, the ability to reference information regarding the provider through the invoice management system assists a manager in managing accounts, by making relevant information accessible to the manager while the manager is reviewing invoices. Additionally, by having a list of the providers, as attributes associated with the provider are obtained, the provider can be marked as having relevant attribute information associated therewith. The ability to track which providers have had attributes associated therewith allows the invoice management system to ensure that attribute information is obtained for all providers associated with a property. As information related to providers may have been previously obtained by the invoice managing system, it may first be determined 1325 whether pre-stored information is available. If pre-stored information is available, the pre-stored information may be retrieved 1328 and associated with the account. If no pre-stored information is available, contact information may be determined 1326 from the client or from the provider itself, and the bill type determined 1327 for invoice receipt purposes.

The provider information to be obtained may include contact information 1326 for the provider, as well as the bill type 1327 associated with the provider. Bill type may be important where automated acquisition of invoice information is to be implemented by the invoice management system. Information for providers may be repetitively obtained until it has been determined 1330 that information for each provider has been obtained.

As well as providing support for customers who manage their own properties, the present invention may be used to support agents who manage properties on behalf of others. Agents may be either third parties acting as managers on behalf of an existing or new customer, or may act as the customer for managing accounts associated with a third party. Where an agent acts as the customer, the agent may desire notifications of actual account owners in association with the provision of the account management service. The definition of the client as an agent may transfer responsibility for fees associated with the provision of the service to the agent, such that the actual account owner may subcontract responsibility for account management for organizational reasons.

If it is determined 1304 that the client type is an agent it may next be determined 1334 whether the agent is acting on behalf of a client, or is acting as the client. The distinction may be utilized elsewhere to control authorities associated by the agent (the account owner may have authority to designate powers to the agent, or such authorities may be vested in the agent), as well as to assess fees associated with the provision of the service. If it is determined 1334 that the agent is acting as the client, the agent may be queried to obtain the agents Employer Identification Number 1336 and other identification 1338, as well as to obtain agent contact information 1340. A username and password may be determined 1342 for the agent. The agent may also be queried to determine the identity of and to associate accounts to be managed, to determine attributes associated with the accounts, and to determine whether the accounts are expected to receive invoices from multiple providers. The agent may then be queried to obtain provider/supplier information associated with any associated accounts, as well as contact information for the provider/suppliers from whom invoices are expected to be received. The invoice types associated with the provider/suppliers may be determined to allow efficient recognition/digitalization of information contained on the invoices. Once all information has been obtained, the sub-process may end.

If it is determined that the agent is acting as the client, but is acting on behalf of a third party, the same information may be gathered, as well as information defining whether information copies associated with invoice management should be copied to the third-party account owner.

To accomplish this, it may be determined 1354 whether the agent desires to, correlate third party account owner information with accounts identified by the agent. Contact information for third party account owner may be obtained 1356 when the agent desires to have such information correlated. Additionally, contact rules, such as when a third party account owner should be involved in the account management process may be obtained 1358.

### Service Administration

Administration of the service includes tasks associated with controlling access to the service, as well as to ensuring that invoices are not improperly misdirected. Simple access controls may be implemented through the use of a user ID and password, such that access to specific invoices, as well as administrative functions, is dependant upon authorization granted to a specific user. Additional levels of security may be implemented, such as encryption of information being transmitted, or implementation of security certificates on individual manager's computers.

Authorization to have billing information provided through the system also may have security issues. The system preferably includes validation functions to ensure that a manager cannot intentionally or accidentally cause an invoice to be included in the system. Where invoices are manually forwarded by the manager to the system for scanning, authorization is a minimal issue. Where, however, electronic forwarding of invoices to the system is requested by a manager, improper identification of an account may result in invoices being displayed for a manager not associated with an invoice.

Requiring a paper submission of a request to have an account associated with the bill payment system provides a record of the request, however does not provide validation of the authority to have the account associated with the system. A simple validation may be implemented by checking invoices to ensure that the person or entity identified as responsible with an account is the individual requesting association of the account with the bill payment system. Alternately, requiring a user to provide a hard copy of an invoice associated with an account before the account can be associated with the bill payment system may reduce improper associations. Finally, forwarding a written authorization request to the addressee of invoices associated with an account may be used to validate the authority of the request, however may be dependant on a provider's willingness to provide the account contact information.

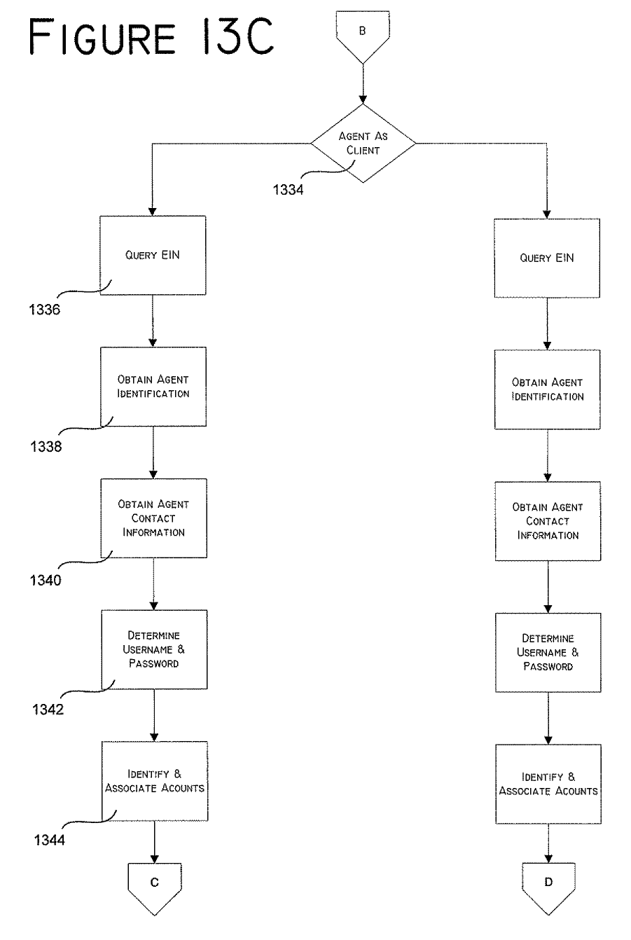

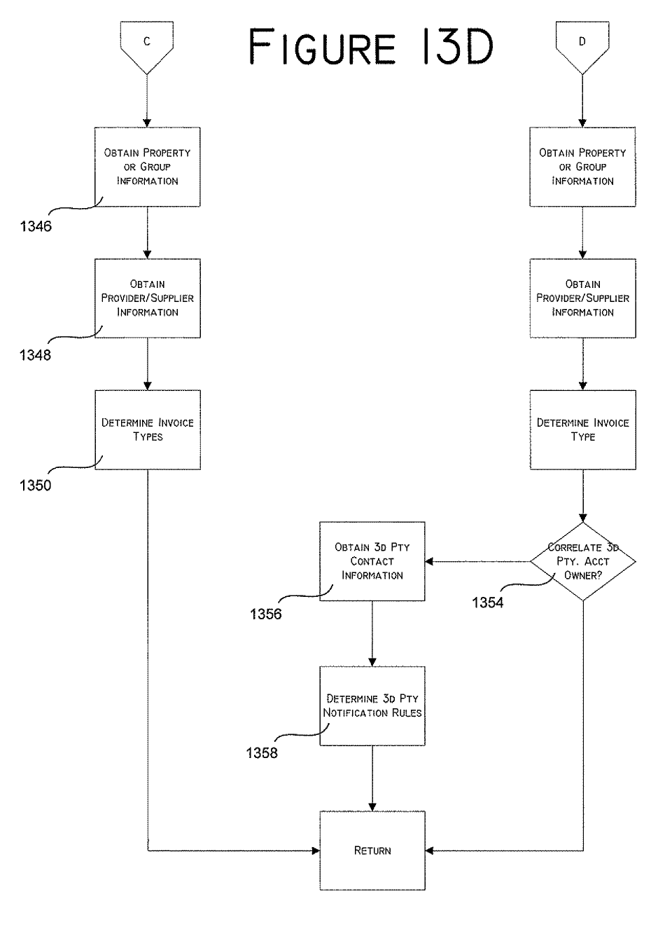

A process for associating an account with the invoice management system is shown in FIG. 14. Such a process is similar to what may occur when a client enrolls with the invoice management system (indeed, may use a sub process of the enrollment process), however some variations may arise where the client is an existing client, and simply wants to add an account to the accounts already being managed through the invoice management center. Once a request to associate an account with the invoice management system is received 1402, the manager making the request may be queried 1404 to provide required information. Required information may include, but is not limited to, parameters for auditing, preferences for payment methods, preferred display types, contact information for an account, and grouping information for the account. The authority of the manager to associate the account may then be verified. If it is determined that the manager does not have the authority to associate the account, the manager can be queried to determine whether the manager desires to associate a different account.

If it is determined 1408 that the manager has the authority to associate the account, the manager may be queried 1410 to determine if the manager desires invoices for the account to be redirected to be sent directly to the invoice management system. If the manager so desires 1412, a request to redirect the invoices directly to the invoice management system may be generated 1414 and forwarded to the provider. Such a request may be transmitted based on contact information provided by the manager, in a manner consistent with the provided information. The account information then may be stored 1416 in a database, pending receipt of an invoice associated with the account.

The account information may include information identifying the timing and frequency of expected invoices, allowing detection of whether an invoice should have been received by a certain time, allowing the manager or a provider to be queried regarding a missing invoice.

The manager may finally be queried 1418 to determine 1420 whether the manager desires to associate another account with the invoice management system, and if so, the request may be treated as another request for associating an account. If the manager indicates that no further accounts are desire to be associated, the process may end 1422.

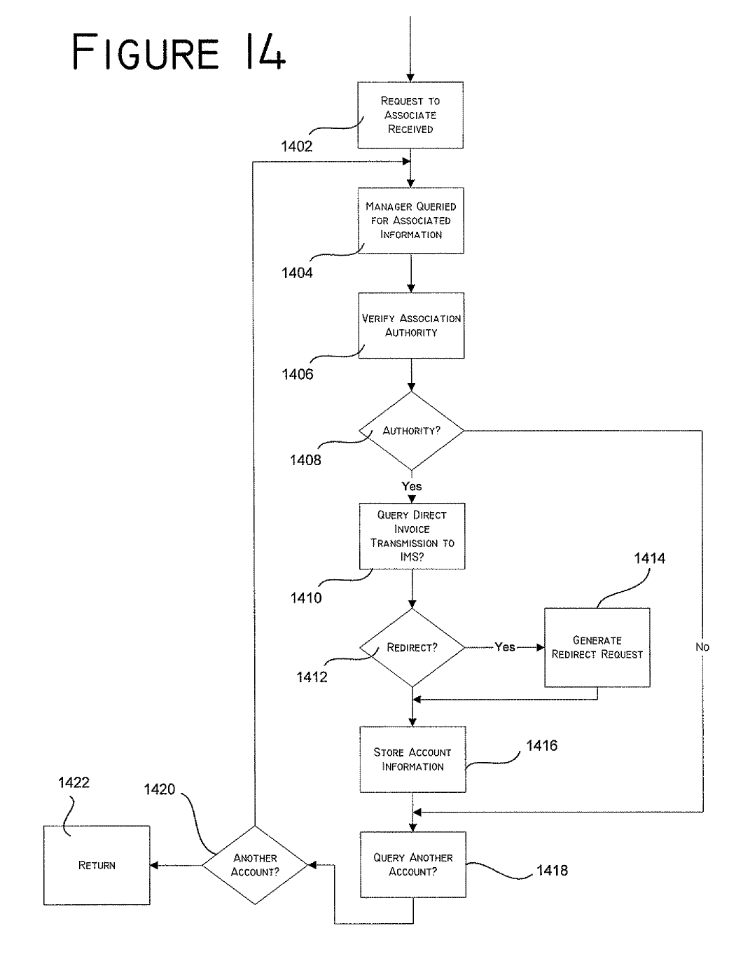

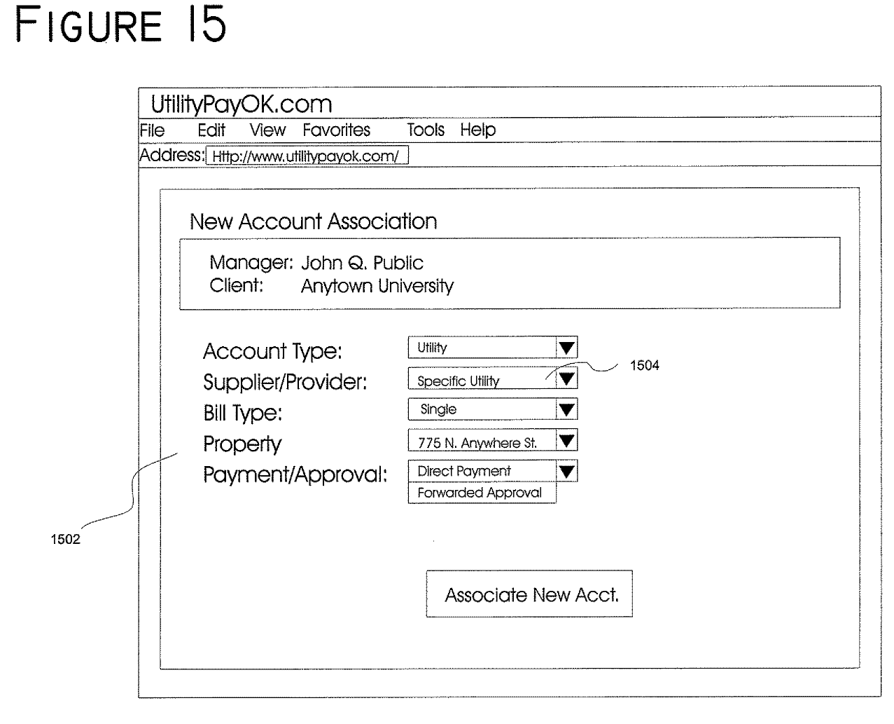

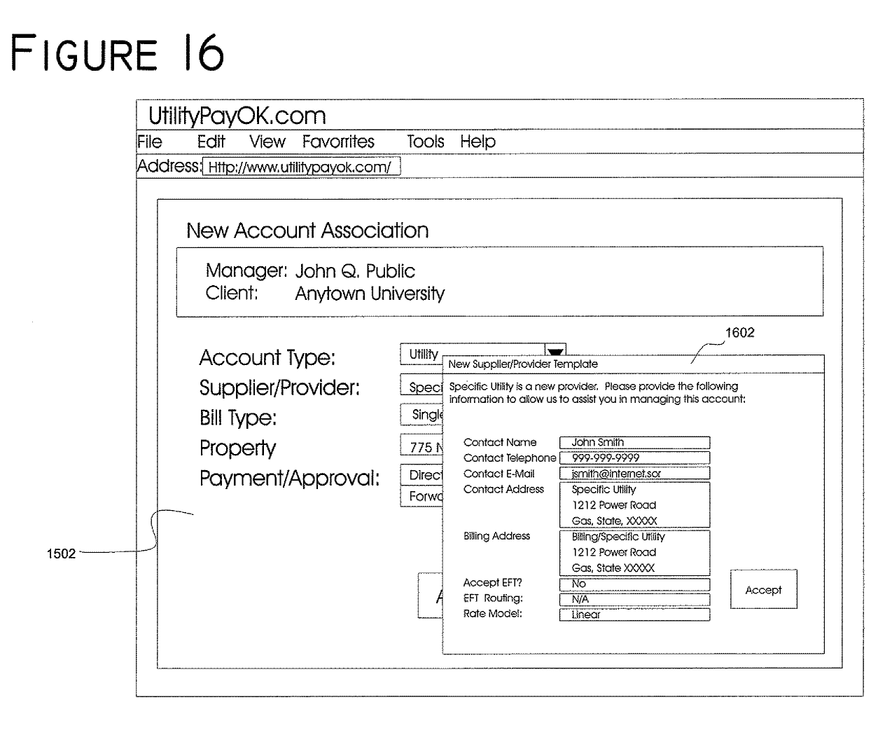

FIG. 15 shows a notional account association screen 1502 indicating information which may typically be requested from a manager when associating an account with the invoice management system. As information is provided through the account association screen, the invoice management system may detect that attributes associated with information provided have not been yet determined. For example, where a utility provider is identified 1504 with a new account, and no information associated with the utility provider is present in the invoice management system database, a window 1602 prompting attributes associated with the utility provider may be displayed, such as shown in FIG. 16. Alternately, where a new property is identified, a property information template 1702 such as shown in FIG. 17 may be generated.

Service administration may also include housekeeping functions associated with the provision of the service. These housekeeping functions may be broken down into maintenance functions and management functions. Maintenance functions may include client assistance, database maintenance, new invoice format intake, and association/disassociation of new clients on accounts. It is preferred that these tasks be automated through the invoice management system, although an individual associated with the service may act as an intermediary between the invoice management system and a client.

Management housekeeping functions may include accounting functions associated with service revenue, usage tracking, and invoice latency tracking. The system may include report generation capabilities associated with these functions.

### Administrative Functions

In addition to associating a new account, a manager may be presented with various screens to allow a client or manager to view or edit information associated with an account.

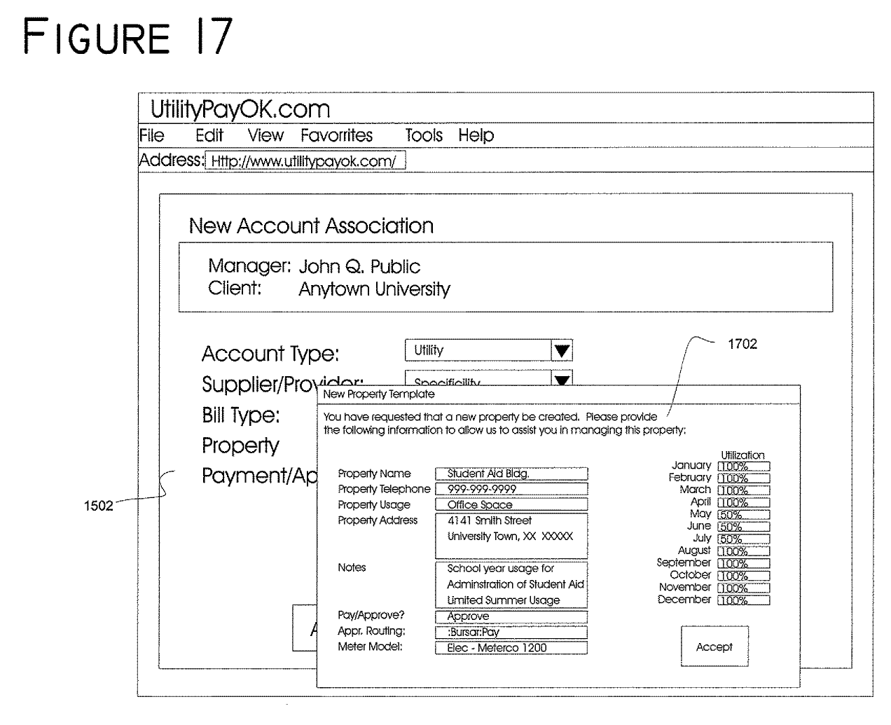

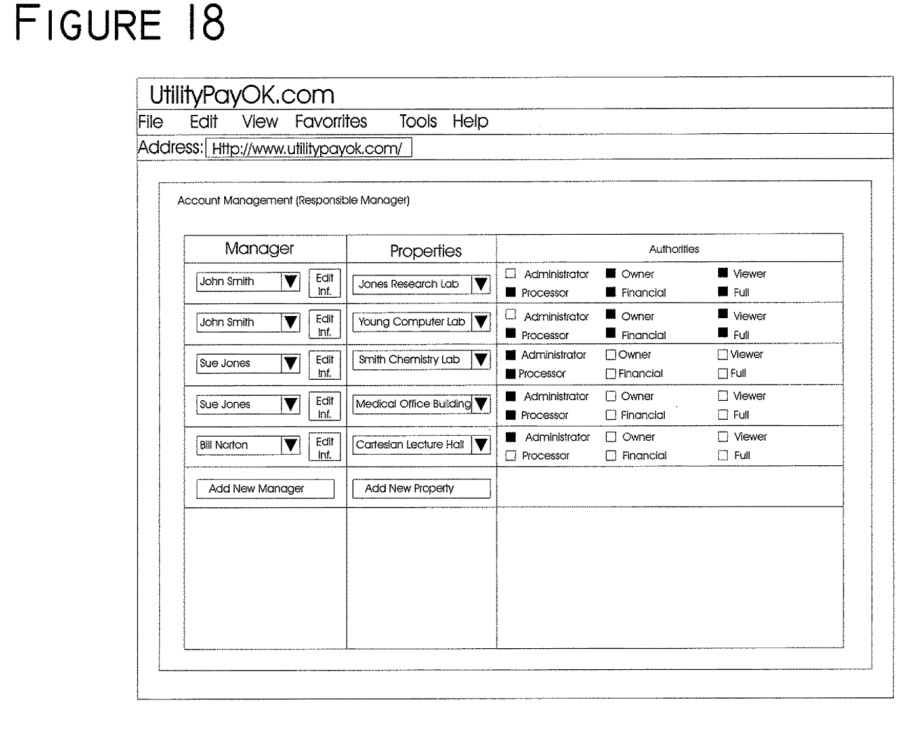

For example, as shown in FIG. 18, a manager may be provided with a manager profile display 1802 to allow a client to control which managers are responsible for which properties (and which accounts). Additionally, toggles can be provided to control approval/payment authority for each manager/account as desired. One possible set of authorities is as shown in the following table:

| Group Name | Description |
|---|---|
| Administrator | This person is effectively all powerful on the site. His |
| | login cannot only impact the entire operation of the site, |
| | but he can update, change, or enter information on any |
| | customer. |
| Owner | The chief customer user. this individual has |
| | administrative power over his entire customer site, or in |
| | the case of an agent, all of the sites he manages. |
| Viewer | This class of user can view the bills, but cannot do |
| | anything else. |
| Processor | This class of user can view the bills, update audit alerts, |
| | and correct apparently erroneous bills, and create |
| | disputes. |
| Financial | This individual can actually pay bills, but that is all. |
| Full | This user class combines processor and financial, but is |
| | not quite as powerful as owner, as this person(s) cannot |
| | change the user or customer information. |

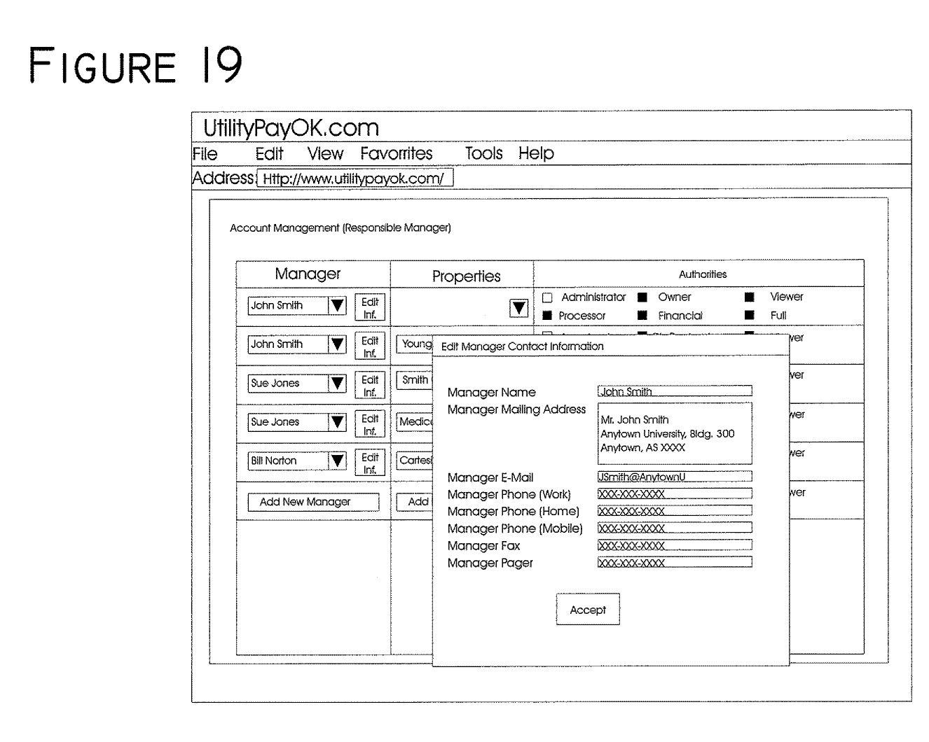

The elements of the manager profile display may be hyperlinked, such that clicking or double-clicking on an element such as a manager's name, would result in a screen allowing attributes associated with that element to be accessed. For example, as shown in FIG. 19, a manager attribute display 1902 could be opened to allow contact information 1904, 1906, 1908, 1910, 1912, 1914, 1916 associated with a manager to be edited.

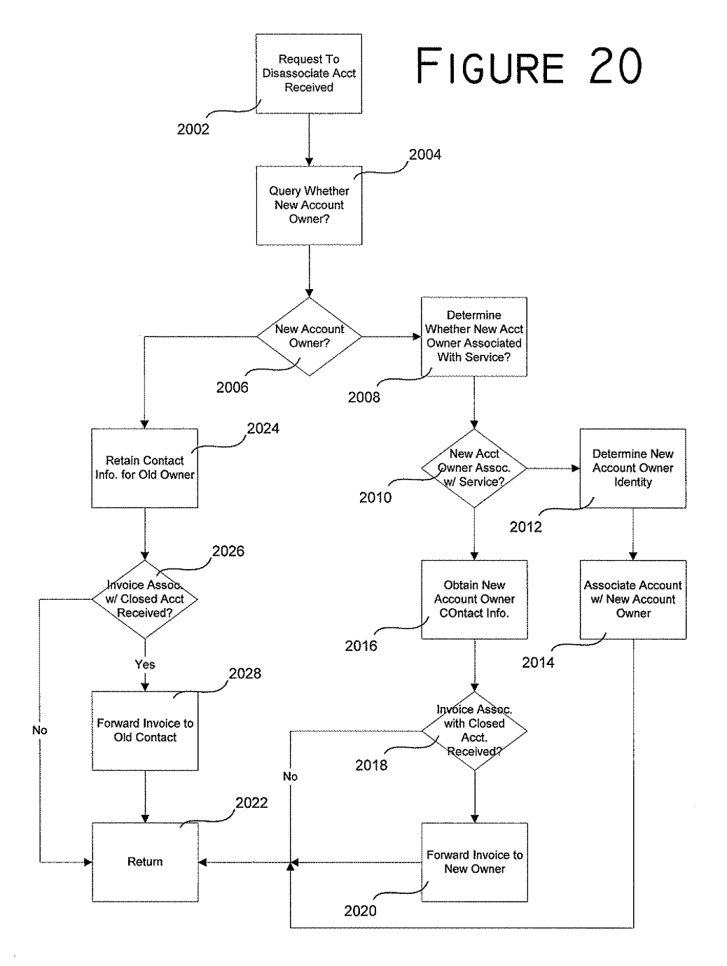

As well as associating new clients with the invoice management system, or new accounts with an associated client, the invoice management system may also be required to disassociate clients or accounts from the system. As a means for ensuring proper tracking of accounts, the system may typically be implemented such that a client can not be disassociated from the invoice management system until each account associated with the client has been disassociated from the system. As shown in FIG. 20, once a request to disassociate an account has been received 2002, the manager may be queried 2004 to determine whether there is a new account owner. If it is determined 2006 that there is a new account owner (ie., the account is to be transferred), it may be determined 2008 whether the new account owner is associated with the invoice management system. If it is determined 2010 that the new account owner is associated with the system, the identity of the new account owner may be obtained 2012, and the account may be associated 2014 with the new account owner. Such a process may typically occur where a new client takes over a building, but wishes to continue to manage accounts associated with the building through the service. In such a situation, the new building owner would enroll as a client, and provide information as described above, such that the old owner could disassociate the account, but the effect of the disassociation would be to associate the account with the new owner. Thus, if an invoice were received, it would be automatically associated with the new owner.

If it is determined 2010 that the new owner is not associated with the invoice management system, contact information for the new owner could be obtained 2016. If an invoice associated with the new owner were received 2018, the invoice could be forwarded 2020 to the new owner at the new owner contact, and the process could end 2022.

If no new owner is identified, the contact information for invoices associated with the account would be retained 2024. Thus, if an invoice associated with the account were received 2026 after disassociation, the invoice could be forwarded 2028 to the old contact information, assuring that the invoice was addressed by a responsible party.

### Database Structure

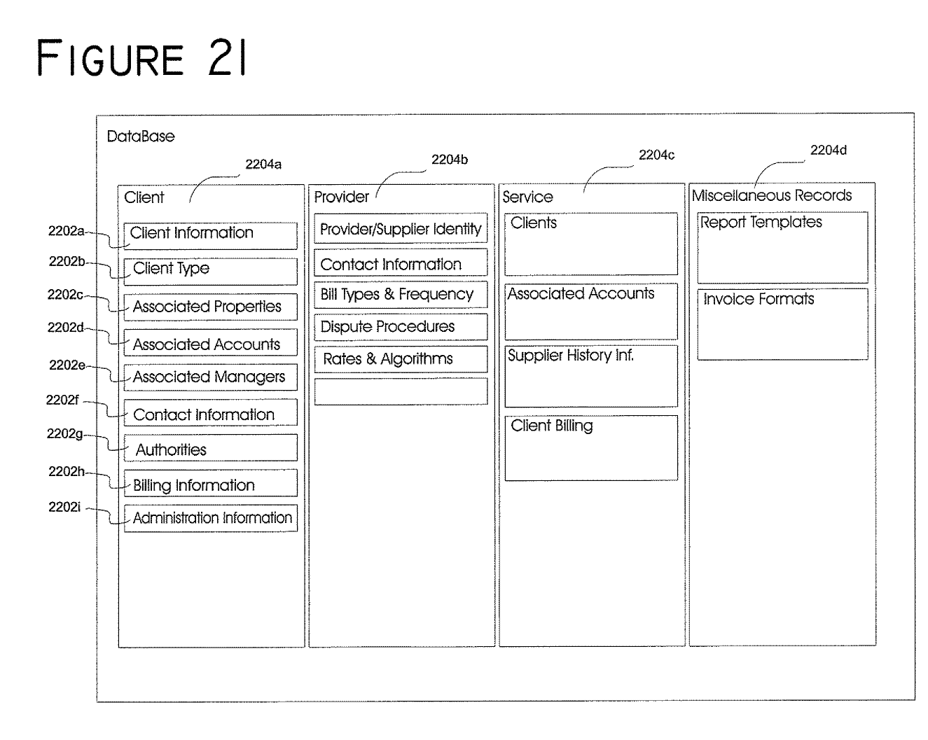

Although the basic building elements of the database are the information elements associated with invoices, the database may include other information, including the audit criteria discussed above. The use of a relational database may allow the linking of different data structures between associated records. For example, a property record may be associated with an invoice, where the property record contains characteristics associated with the property, such as a geographic reference, or a grouping reference requested by a manager. Elements which may be stored in the database are shown throughout the notational displays discussed above. FIG. 21 shows illustrative database elements 2102a, 2102b, 2102c and groupings as 2104a, 2104b, 2104c, and 2104d, may be utilized in the present invention. Additional information may be stored to assist a manager in managing invoices associated with a property, including but not limited to the size and usage of the property, occupancy information, information identifying equipment located at the property and associated with the provided service, or internal contact information associated with the property.

Furthermore, additional account grouping structures may be provided to a manager to allow the manager to manage multiple invoices associated with a property, or a collection of properties, such as based on usage or geographic location. Such additional groupings may be implemented through the use of relational databases, where identifiers associated with records identify the relation of the record to other records.

### Group Bills

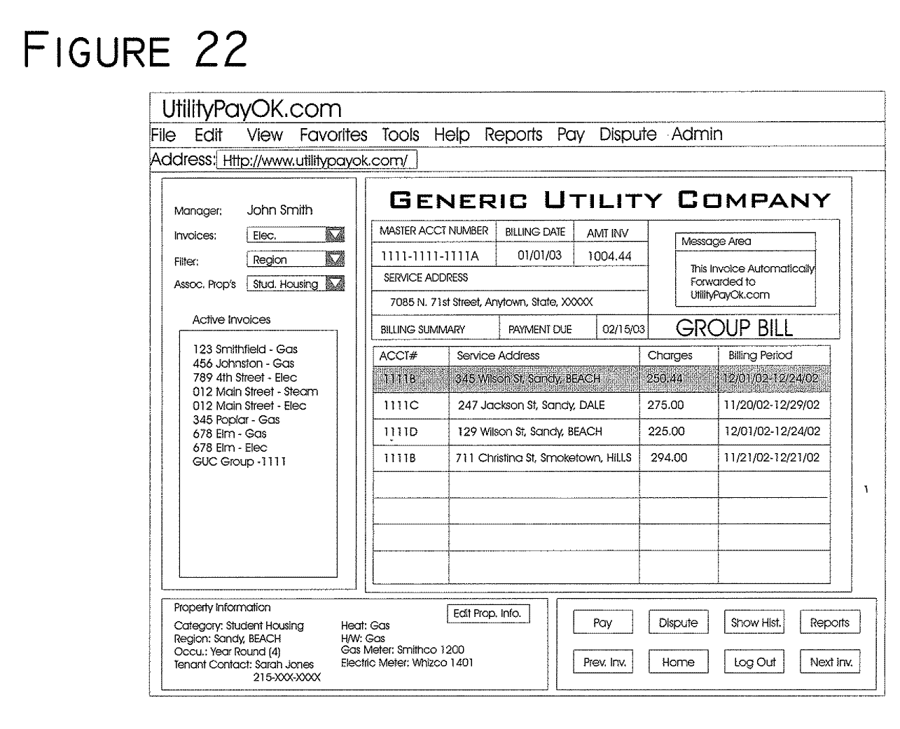

In addition to being able to assist a manager in managing individual invoices, the present invoice management system may be adapted to assist in the management of group bills. Group bills are invoices received from a single provider covering multiple accounts or goods or services associated with multiple properties or tasks, where individual charges are associated with an identifier for an account, property, or task. A notional group bill is shown in FIG. 22, as could be received in association with an invoice from a utility provider, wherein the invoice covers multiple properties 2202a, 220b, . . . with multiple accounts 2204a, 2204b . . . associated with the properties.

Group bills may be presented to a manager in a display format consistent with the provided group bill, or in a custom format. The presentation may show multiple entries associated with the charge for each account, property, or task. The presentation may provide a drill down display to allow a manager to generate a presentation showing details for each line item. Such a drill down may be requested by clicking on a displayed line item, to show details associated with the charge, or with stored information associated with the individual account, property, or task. The drill down displays may utilize the presentations discussed above, such as shown in FIG. 7.

Disputes for group bill charges may be desired on a charge by charge basis. A manager may be provided with a method for generating such a dispute, either from the group bill presentation, or from a detail view for an individual charge. Initiation of a dispute may cause a dispute template to be presented to the manager, as discussed above. Where elements of a group bill are disputed, the group bill presentation may adjust a group bill amount downward to reflect disputed amounts.

Group bills provide an additional issue with regards to administration of the group bills. A charge for an account, property, or task may appear on a group bill without previously having been associated with the manager. In such a situation, the system may either hide information associated with the non-associated account, property, or task (and inform the provider of the group bill with notice of the misdirected charge), or may include the information in the group bill presentation, but prompt a manager to confirm whether or not the account, property or task with which the charge is associated should be associated with the manager. If a manager indicates a desire to associate the account, property, or task with which the charge is associated with accounts for which the manager is responsible, the manager may be prompted to provide background information for the account, property or task as discussed above.

As an additional feature to prevent unintended payment for non-associated charges, the invoice management system may automatically flag for review any charges which were not previously associated with the invoice management system, or automatically generate a dispute over the charge for the account, property or task which had not been previously associated with the invoice management system. Finally, as a means of ensuring that charges for non-associated accounts, properties, or tasks do not get resolved through the invoice management system, the system may block payment of charges associated with non-associated accounts, properties, or tasks, until such account, property or task is associated with the manager in the invoice payment system.

### Revenue Collection Methods

The present invention further supports a novel method for financing provision of the method as a business concern. As the purpose of the system is to create efficiencies for managers by improving their ability to detect, dispute, and track improper charges for services provisions, determining service charges associated with use of the service may be associated with disputed amounts as a means of generating revenue for the bill payment service in proportion to the benefit provided to managers.

The use of disputed amounts as a basis for service charges associated with provision of the service mitigates the impact of the service fee on managers. Unless an amount is successfully detected and disputed, the cost of the improperly assessed charge would be paid, resulting in inefficient utilization of funds available to the manager. Thus, assessing the operating costs of the invoice management system as a function of a client's avoided disbursements allows client's to obtain the benefit of the service without creating an expenditure for receiving the service.

Although simply funding the provision of services based on disputed amounts has its merits, it is likely preferable to use a hybrid charging system based both on system usage and on successfully disputed amounts. Accordingly, a portion of the revenue basis could be founded based on a per account managed basis, while a separate portion would be based on a percentage of successfully disputed amounts.

The description of the present invention as provided herein illustrates the principals and advantages of the present invention, and is provided to enable any person skilled in the art to make and use the present invention. Various modifications to these embodiments will be readily apparent to those skilled in the art, and the generic principles defined herein may be applied to other embodiments without the use of the inventive faculty. Thus, the present invention is not intended to be limited to the embodiments described above, but is to be accorded the widest scope consistent with the principles and novel features disclosed herein.

What is claimed is:

1. An invoice management system for supporting managers in managing invoices, comprising:
an invoice management processor;
at least one interface for receiving invoices from at least one provider;
a network interface for presenting invoices to managers;
wherein said invoice management processor comprises software for assisting said managers in communicating information associated with a disputed invoice to a provider associated with the disputed invoice.

2. An invoice management system according to claim 1, wherein said invoice management system further comprises a database containing information for assisting a manager in communicating information associated with a disputed invoice, said information comprising an address for receiving communications communicating information associated with a disputed invoice.

3. An invoice management system according to claim 2, wherein said information comprising an address comprises information generic to a provider and information specific to a disputed invoice.

4. An invoice management system according to claim 3, wherein said information further comprises identification of a preferred method for communicating information associated with a disputed invoice.

5. An invoice management system, according to claim 3, wherein said information further comprises a format requested by a provider for receiving information associated with a disputed invoice.

6. An invoice management system according to claim 1, wherein said interface for receiving invoices comprises a network interface for receiving invoices in an electronic format.

7. An invoice management system according to claim 1, wherein said interface for receiving invoices comprises a scanner and invoice recognition functionality, said invoice recognition functionality comprising character recognition functionality and a template associating recognized characters with data fields on the invoice.

8. An invoice management system according to claim 1, wherein said invoice management processor comprises auditing functionality, said auditing functionality comparing invoice data with predetermined criteria to determine whether said invoice data indicates a potentially erroneous value.

9. An invoice management system according to claim 1, wherein said invoice management processor comprises auditing functionality, said auditing functionality comparing invoice data with information associated with prior invoices to determine whether said invoice data indicates a potentially erroneous value.

10. An invoice management system according to claim 1, wherein said invoice management processor comprises auditing functionality, said auditing functionality comparing invoice data with provider associated information to determine whether said invoice data indicates a potentially erroneous value.

11. An invoice management system according to claim 1, wherein said invoice management processor comprises auditing functionality, said auditing functionality comparing invoice data with pre-determined criteria, with information associated with prior invoices, and with provider associated information to determine whether said invoice data indicates a potentially erroneous value.

12. A process for assisting managers in managing invoices, said process comprising the steps of:
enrolling a customer with an invoice management system;
associating at least one account for which invoices are expected with an invoice management system;
associating said at least one account with a customer associated with said account;
receiving an invoice associated with said account;
auditing said invoice to detect potential bases for disputing said invoice;
presenting said invoice to a manager associate with said customer, said presentation identifying potential bases for disputing said invoice determined by auditing said invoice;
determining whether said manager desires to dispute at least a portion of said invoice; and
when said manager indicates a desire to dispute at least a portion of said invoice, obtaining from said manager information defining the disputed portion of the invoice and communicating said information to a provider responsible for said invoice.

13. A process for assisting managers in managing invoices according to claim 12, wherein auditing comprises comparing information associated with said invoice with historical information associated with an account with which the invoice is associated.

14. A process for assisting managers in managing invoices according to claim 12, wherein auditing comprises comparing information associated with said invoice with information associated with a provider issuing said invoice.

15. A process for assisting managers in managing invoices according to claim 12, wherein auditing comprises comparing information associated with equipment used to generate said invoice with information characterizing the reliability of the equipment used to generate said invoice.

16. A process for assisting managers in managing invoices according to claim 12, wherein auditing comprises comparing information associated with said invoice with information identified by a customer for auditing purposes.

17. A process for assisting managers in managing invoices according to claim 16, wherein said information identified by a customer comprises identification of accounts associated with the customer.

18. A process for assisting managers in managing invoices according to claim 12, further comprising the step of obtaining information associated with a dispute process from a database when a manager indicates a desire to dispute at least a portion of said invoice.

19. A process for assisting managers in managing invoices according to claim 18, wherein said information associated with a dispute process comprises information identifying a provider-associated address for receiving communications communicating information associated with a disputed invoice.

20. A process for assisting managers in managing invoices according to claim 19, wherein said provider associated address is an electronic destination for electronic transmission of information associated with a disputed invoice.

21. A process for assisting managers in managing invoices according to claim 20, wherein said provider-associated address is an e-mail address.

22. A process for assisting managers in managing invoices according to claim 20, wherein the step of communicating information comprises communicating information in a format compatible with provider associated software for receiving information associated with disputed invoices.

23. A process for assisting managers in managing invoices according to claim 12, wherein the step of obtaining from said manager information defining the disputed portion of the invoice comprises presenting a template for receiving said information, said template identifying information desired by a provider associated with said invoice.

24. A process for assisting managers in managing invoices according to claim 23, wherein said template displays previously stored information desired by a provider associated with said invoice.

25. A process for assisting managers in managing invoices according to claim 24. wherein said previously stored information comprises the managers contact information.

26. A process for assisting managers in managing invoices according to claim 24, wherein said invoice comprises a plurality of values defining parameters of the invoice, and said template queries said manager for identification of which value is being disputed.

27. A computer readable media tangibly embodying instructions, which when executed by a computer implement a process comprising the steps of:
receiving an invoice from a provider;
auditing said invoice to identify values likely to be disputed;
presenting said invoice to a manager, said presentation identifying values likely to be disputed;
querying said manager whether said manager desires to dispute presented values; and
when said manager desires to dispute a presented value, assisting said manager in disputing said value.

28. A computer readable media according to claim 27, wherein auditing said invoice comprises comparing information associated with said invoice with historical information associated with an account with which the invoice is associated.

29. A computer readable media according to claim 27, wherein auditing said invoice comprises comparing information associated with said invoice with information associated with a provider issuing said invoice.

30. A computer readable media according to claim 27, wherein auditing said invoice comprises comparing information associated with equipment used to generate said invoice with information characterizing the reliability of the equipment used to generate said invoice.

31. A computer readable media according to claim 27, wherein auditing said invoice comprises comparing information associated with said invoice with information identified by a customer for auditing purposes.

32. A computer readable media according to claim 31, wherein said information identified by a customer comprises identification of accounts associated with the customer.

33. A computer readable media according to claim 27, further comprising the step of obtaining information associated with a dispute process from a database when a manager indicates a desire to dispute at least a portion of said invoice.

34. A computer readable media according to claim 33, wherein said information associated with a dispute process comprises information identifying a provider-associated address for receiving communications communicating information associated with a disputed invoice.

35. A computer readable media according to claim 34, wherein said provider associated address is an electronic destination for electronic transmission of information associated with a disputed invoice.

36. A computer readable media according to claim 35, wherein said provider-associated address is an e-mail address.

37. A process for assisting managers in managing invoices according to claim 35, wherein the step of communicating information comprises communicating information in a format compatible with provider associated software for receiving information associated with disputed invoices.

38. A computer readable media according to claim 27, wherein the step of obtaining from said manager information defining the disputed portion of the invoice comprises presenting a template for receiving said information, said template identifying information desired by a provider associated with said invoice.

39. A computer readable media according to claim 38, wherein said template displays previously stored information desired by a provider associated with said invoice.

40. A computer readable media according to claim 39, wherein said previously stored information comprises the managers contact information.

41. A process for assisting managers in managing invoices according to claim 39, wherein said invoice comprises a plurality of values defining parameters of the invoice, and said template queries said manager for identification of which value is being disputed.

42. A method for financing an invoice management system having invoice dispute capabilities, comprising the steps of:
recording when an invoice is disputed by a manager;
determining whether the dispute resulted in a reduction of the invoice amount;
assessing a fee for provision of the invoice management service as a function of the reduction of the invoice amount.

43. A method for financing an invoice management system according to claim 42, further comprising assessing a fee for provision of the invoice management services for a plurality of accounts associated with the service as a function of the number of accounts associated with the service.
